(19) United States
(12) Patent Application Publication
(10) Pub. No.: US 2010/0063682 A1
(43) Pub. Date: Mar. 11, 2010

(54) Overturning prevention device for forklift vehicle

(76) Inventor: Tomihiro AKAKI, Hyogo (JP)

Correspondence Address: WENDEROTH, LIND & PONACK, L.L.P., 1030 15th Street, N.W.,, Suite 400 East, Washington, DC, 20005-1503, US

(21) Appl. No.: 11/660,999

(22) PCT Filed: Nov. 18, 2005
(86) PCT No.: PCT/JP2005/021209

§ 371 Date: Oct. 8, 2008

(30) Foreign Application Priority Data
Nov. 19, 2004 (JP) 2004-335475

(51) Int. Cl. G06F 7/00

(52) U.S. Cl. 701/42; 701/50; 701/41

(57) ABSTRACT

A subject of the present invention is to provide an overturning prevention apparatus for a forklift with various means. A cargo height H is calculated from a piston displacement detected by a displace sensor 21 and a cargo weight W is calculated by pressure P detected by a pressure sensor 22. A controller 20 detects a limit speed V1 in the case of non-cargo weight and a limit speed V2 in the case of the maximum cargo weight. By linearly interpolating the limit speeds V1 and V2, limit velocity Vc in the case that the cargo weight is W by utilizing a minimum turning radius memorized in the controller as a turning radius. If an actual velocity Va measured by a velocity sensor 23 is reached to the limit velocity Vc, the warning device 30 is actuated for warning an operator.

### FIELD OF THE INVENTION

The present invention relates to an overturning prevention device for a forklift vehicle.

### BACKGROUND OF THE INVENTION

In the case that a running forklift vehicle turns without reducing velocity sufficiently, the forklift vehicle might be overturned by applying large lateral force.

In order to prevent for occurring such a phenomenon, the patent document 1 shows a device. The device detects a current steering amount, a cargo position and a cargo weight. In accordance with such detected values, a limit overturning prevention angle is calculated. Further, an overturning prevention velocity is calculated in accordance with the limit overturning prevention angle so that vehicle velocity can be controlled.

Patent Publication 1: Japanese Patent Laid-open Publication 10-175800

### DISCLOSURE OF THE INVENTION

### Subject Solved by the Invention

The above Patent Publication 1 discloses that the limit overturning prevention angle is calculated by detecting a current steering amount, a cargo position and cargo weight so as to obtain an overturning prevention vehicle velocity and then the vehicle velocity is controlled not to over the overturning prevention vehicle velocity. However, the Patent Publication 1 does not disclose any other methods.

A purpose of the present invention is to provide various overturning prevention devices applied for a forklift vehicle.

### Means to Solve the Subject

In accordance with the present invention as claimed in claim 1, the present invention provides an overturning prevention apparatus for a forklift vehicle comprising cargo height detection means, cargo weight detection means, minimum turning radius memory means, limit velocity calculation means for calculating a limit velocity at which a forklift is not overturned in accordance with a cargo height, a cargo weight and the minimum turning radius, actual vehicle velocity detection means; velocity comparison means for comparing with an actual vehicle velocity and said limit velocity; and warning device for warning to an operator, wherein said apparatus is characterized in that said warning device is begun to be actuated in the case that actual velocity is reached to said limit velocity.

The present invention as claimed in claim 2 provides an overturning prevention apparatus for a forklift vehicle in claim 1 characterized in that warning is actuated in multi-steps depending a difference degree between said actual vehicle velocity and said limit velocity in a duration before said actual vehicle velocity reached to said limit velocity.

The present invention as claimed in claim 3 provides an overturning prevention apparatus for a forklift vehicle in claim 1, said apparatus further comprising vehicle velocity presumption means for presuming vehicle velocity at a moment after the predetermined period from the present time in accordance with a present vehicle velocity, wherein said apparatus is characterized in that said velocity comparison means compare with a vehicle velocity presumed by said vehicle velocity presumption means and said limit velocity and said warning device is actuated in the case that said presumed vehicle velocity is reached to said limit velocity.

The present invention as claimed in claim 4 provides an overturning prevention apparatus for a forklift vehicle in claim 1 characterized in that one of decelerating vehicle velocity, lowering said cargo height and prohibiting an incensement of a steering rotational angle is operated after said warning device is actuated.

The present invention as claimed in claim 5 provides an overturning prevention apparatus for a forklift vehicle comprising cargo height detection means, cargo weight detection means, minimum turning radius memory means, limit velocity calculation means for calculating a limit velocity at which said forklift is not overturned in accordance with a cargo height, a cargo weight and the minimum turning radius, actual vehicle velocity detection means, velocity comparison means for comparing with an actual vehicle velocity and said limit velocity and cargo height lowering device, wherein the apparatus is characterized in that said cargo height lowering device is begun to lower said cargo height in the case that said actual vehicle velocity is over the limit velocity.

The present invention as claimed in claim 6 provides an overturning prevention apparatus for a forklift vehicle as claimed in claim 5, wherein said apparatus further comprises deceleration means and said apparatus is characterized in that said deceleration means is begun to be actuated in the case that said actual vehicle velocity is over said limit velocity.

The present invention as claimed in claim 7 provides an overturning prevention apparatus for a forklift vehicle as claimed in claim 6, said forklift comprising an acceleration pedal, wherein said apparatus is characterized in that said deceleration means is acceleration shutting means for shutting a connection between an input of pushing said acceleration pedal by an operator and driving means.

The present invention as claimed in claim 8 provides an overturning prevention apparatus for a forklift vehicle as claimed in claim 6, wherein said forklift is driven by an internal combustion engine, wherein said apparatus is characterized of further comprising an output control device for controlling output of said internal combustion engine in order to maintain vehicle velocity less than said limit velocity.

The present invention as claimed in claim 9 provides an overturning prevention apparatus for a forklift vehicle as claimed in claim 6, wherein said apparatus is characterized in that said deceleration means is braking means for braking a vehicle.

The present invention as claimed in claim 10 provides an overturning prevention apparatus for a forklift vehicle, wherein said apparatus is characterized of comprising limit rolling moment calculation means and actual rolling moment calculation means and said apparatus is characterized in that said braking means decelerate a vehicle velocity in the case that said actual rolling moment is greater than said limit rolling moment.

The present invention as claimed in claim 11 provides an overturning prevention apparatus for a forklift vehicle as claimed in claim 10, wherein said apparatus characterized in that said braking means decelerate said vehicle velocity and prohibit an incensement of a steering angle in the case that said actual rolling moment is greater than said limit rolling moment.

The present invention as claimed in claim 12 provides an overturning prevention apparatus for a forklift vehicle as claimed in claim 10, wherein said apparatus further comprising cargo height detection means, cargo weight detection means and lateral acceleration detection means for detecting lateral acceleration along a lateral direction of a vehicle.

The apparatus is characterized in that said limit rolling moment calculation means calculate limit rolling moment in accordance with a cargo height detected by said cargo height detection means and a cargo weight detected by said cargo weight detection means and said actual rolling moment calculation means calculate said rolling moment in accordance with said cargo height detected by said cargo height detection means, said cargo weight detected by said cargo weight detection means and lateral acceleration detected by said lateral acceleration detection means.

The present invention as claimed in claim 13 provides an overturning prevention apparatus for a forklift vehicle as claimed in claim 12, said apparatus characterized in that said lateral acceleration detection means is a lateral acceleration sensor mounted on a vehicle body.

The present invention as claimed in claim 14 provides an overturning prevention apparatus for a forklift vehicle as claimed in claim 12, wherein said acceleration detection means includes wheel steering angle detection means and yaw rate detection means attached to said vehicle body. The apparatus is characterized in that said lateral acceleration detection means detect lateral acceleration in accordance with a wheel steering angle detected by said wheel steering angle detection means and a yaw angular velocity detected by said yaw rate detection means.

The present invention as claimed in claim 15 provides an overturning prevention apparatus for a forklift vehicle as claimed in one of claim 10 through claim 14, wherein said apparatus comprising rolling moment presumption means for presuming rolling moment at a moment after a predetermined period. The apparatus is characterized in that said rolling moment presumed by said rolling moment presumption means is compared to said limit rolling moment.

The present invention as claimed in claim 16 provides an overturning prevention apparatus for a forklift vehicle comprising cargo height detection means, cargo weight detection means, minimum turning radius memory means, limit velocity calculation means for calculating a limit velocity at which said forklift is not overturned in accordance with a cargo height, a cargo weight and the minimum turning radius, actual vehicle velocity detection means, velocity comparison means for comparing with an actual vehicle velocity and the limit velocity, a braking device for braking a vehicle and a steering resistant device for applying resistant force against a steering device.

The apparatus is characterized in that said braking device and said steering resistant device are begun to be actuated in the case that actual vehicle velocity is reached to said limit velocity.

The present invention as claimed in claim 17 provides An overturning prevention apparatus for a forklift vehicle characterized of comprising cargo height detection means, cargo weight detection means, front-rear direction gravity point detection means for detecting a gravity point of a vehicle along a front-rear direction of a vehicle in accordance with a cargo height detected by said cargo height detection means and a cargo weight detected by said cargo weight detection means of said vehicle, vertical direction gravity point detection means for detecting a gravity point of a vehicle along a vertical direction, allowable acceleration presumption means for presuming allowable acceleration in order to avoid for overturning in accordance with said front-rear direction gravity point detected by said front-rear direction gravity point detection means and said vertical direction gravity point detection means and running torque control means for controlling running torque not to over said allowable acceleration presumed by said allowable acceleration presumption means.

The present invention as claimed in claim 18 provides an overturning prevention apparatus for a forklift vehicle as claimed in claim 17, wherein said apparatus is characterized in that said running torque control means compute allowable torque judging from allowable acceleration presumed by said allowable acceleration presumption means and control command torque to a driving motor in accordance with said allowable torque.

The present invention as claimed in claim 19 provides an overturning prevention apparatus for a forklift vehicle as claimed in claim 17, wherein said apparatus further comprising wheel steering angle presumption means for presuming a wheel steering angle and allowable velocity presumption means for presuming allowable velocity not to overturn a vehicle along a lateral direction of said vehicle in accordance with said vertical direction gravity point detected by said vertical direction gravity point detection means and said wheel steering angle presumed by said wheel steering angle presumption means.

The apparatus characterized in that said running torque control mean control said running torque not to over said allowable acceleration presumed by said allowable acceleration presumption means and said allowable velocity presumed by said allowable velocity presumption means.

The present invention as claimed in claim 20 provides an overturning prevention apparatus for a forklift vehicle as claimed in claim 19, wherein said apparatus is characterized in that said running torque control means compute allowable torque in accordance with said allowable torque computed by said allowable acceleration presumed by said allowable acceleration presumption means or said allowable velocity presumed by said allowable velocity presumption means and control command torque to a driving motor in accordance with said allowable torque.

### EFFECT OF THE INVENTION

According to the present invention as claimed in claim 1 through claim 4, warning is occurred in accordance with a vehicle velocity so that a forklift vehicle can be prevented from being overturned. Particularly, according to the present invention as claimed in claim 2, warning is occurred in multi-steps so that an operator can prevent the vehicle from being overturned sufficiently. According to the present invention as claimed in claim 3, warning is occurred in accordance with a presumption velocity after a predetermined period from the present time so that an operator can prevent the vehicle from being overturned sufficiently. According to the present invention as claimed in claim 4, one of deceleration of a vehicle, lowering a cargo height and a prohibit of increasing a steering rotational angle is operated after warning so that an operator is not surprised of a selected operation since the warning is already recognized by the operator.

According to the present invention as claim 5 through claim 9, if a vehicle velocity is reached to the limit velocity, a cargo height becomes lower so as to prevent an overturning phenomenon. Particularly, according to the present invention as claimed in claim 6 through claim 9, the vehicle velocity becomes slower and an operator can drive more safety.

According to the present invention as claimed in claim 10 through claim 15, an overturning prevention control for driving a forklift vehicle is operated in order to control a rolling moment under the limit moment. Particularly, according to the present invention as claimed in claim 15, an overturning prevention control is operation in accordance with a presumption rolling moment at a moment after a predetermined period from the present time.

According to the present invention as claimed in claim 17 through claim 20, an allowable acceleration at which with vehicle is not overturned toward a front-rear direction is presumed so that an overturning phenomenon can be avoided in the case that a vehicle drives rapidly. Particularly, according to the present invention as claimed in claim 19 and claim 20, an overturning prevention phenomenon towards not only the front-rear direction but also the lateral direction can be avoided so that the vehicle can be driven with high safety.

### BRIEF DESCRIPTION OF THE DRAWINGS

FIG. 1 explains the first embodiment. FIG. 1(A) shows a structure thereof and FIG. 1(B) is a signal flow chart.

FIG. 2 explains control relations in the first embodiment.

FIG. 3 explains the first modified control step S15′ of the first embodiment instead of a control step S15.

FIG. 4 explains the second modified control of the first embodiment. FIG. 4(A) shows a step S14′ between the step S14 and the step S15 in FIG. 2 and FIG. 4(B) shows a step S15″ instead of the step S15 in FIG. 2.

FIG. 5 explains the second embodiment. FIG. 5(A) shows a structure thereof and FIG. 5(B) is a signal flow chart.

FIG. 6 explains a hydraulic control device and a relief valve.

FIG. 7 explains control relations in the second embodiment.

FIG. 8 explains control a modified example of the second embodiment. FIG. 8(A) shows a structure thereof and FIG. 8(B) is a signal flow chart.

FIG. 9 explains a control step 25′ in the modified example of the second embodiment.

FIG. 10 explains the third embodiment. FIG. 10 (A) shows a structure thereof and FIG. 10(B) is a signal flow chart.

FIG. 11 explains a brake control device of the third embodiment.

FIG. 12 explains a control system of the third embodiment.

FIG. 13 explains the first modified example of the third embodiment. FIG. 13(A) shows a structure thereof and FIG. 13 (B) shows a signal flow chart.

FIG. 14 explains a structure of a steering resistance device as the first modified example of the third embodiment.

FIG. 15 explains a step S35′ in the first modified example of the third embodiment.

FIG. 16 explains the second modified control example of the third embodiment. FIG. 16(A) explains the step S32′ and FIG. 16(B) explains the step S34′.

FIG. 17 explains the fourth embodiment. FIG. 17(A) is a structure thereof and FIG. 17(B) is a signal flow chart.

FIG. 18 explains a control system of the fourth embodiment.

FIG. 19 explains a modified control example of the fourth embodiment. FIG. 19 (A) explains a step S43a and FIG. 19(B) explains a step S44′.

FIG. 20 explains the fifth embodiment. FIG. 20(A) is a structure thereof and FIG. 20(B) is a signal flow chart.

FIG. 21 explains a control system of the fifth embodiment.

FIG. 22 shows a system structure of the sixth embodiment.

FIG. 23 is a block diagram of an allowable torque treatment process of the sixth embodiment.

FIG. 24 is a system structure of the seventh embodiment.

FIG. 25 shows a block diagram of an allowable torque treatment process of the seventh embodiment.

FIG. 26 (a) shows an arrangement of three limit switches SW₁, SW₂ and SW₃. FIG. 26(b) shows a graph for indicating a relation between an actual lift height and a calculated value.

FIG. 27 shows a mast mechanism.

FIG. 28 shows a graph for forecasting a wheel steering angle.

FIG. 29 is a side view of a forklift truck.

FIG. 30 is a front view of a forklift.

FIG. 31 is a graph for indicating a relation between a count number and time in an encoder.

### DESCRIPTION OF REFERENCE NUMERALS

Numeral 2 indicates a vehicle body. Numeral 3 indicates an output control device. Numeral 11 indicates an outer mast. Numeral 12 indicates an inner mast. Numeral 13 indicates a fork. Numeral 14 indicates a lift cylinder. Numeral 15 indicates a piston. Numeral 16 indicates a hydraulic control device. Numeral 17 is a lift lever. Numeral 18 indicates a tilt device. Numeral 20 indicates a controller. Numeral 21 indicates a displacement sensor. Numeral 22 indicates a pressure sensor. Numeral 23 indicates a velocity sensor. Numeral 24 indicates an accelerator open degree sensor. Numeral 25 indicates an engine revolution sensor. Numeral 26 indicates a relief valve. Numeral 27 indicates a (lateral direction) acceleration sensor. Numeral 28 indicates a gyro sensor. Numeral 29 indicates a wheel steering sensor. Numeral 30 indicates a warning device. Numeral 110 indicates a lift cylinder. Numeral 120 indicates an accelerator. Numeral 130 is a front-rear lever. Numeral 140 indicates a displacement sensor. Numeral 150 indicates a pressure sensor. Numeral 160 indicates a velocity sensor. Numeral 170 indicates a controller. Numeral 180 indicates a driving motor. Numeral 190 indicates a steering device. Numeral 200 indicates an angular sensor.

### THE BEST MODE FOR EMBODYING THE INVENTION

With reference to the accompanying drawings, each embodiment of the present invention will be explained.

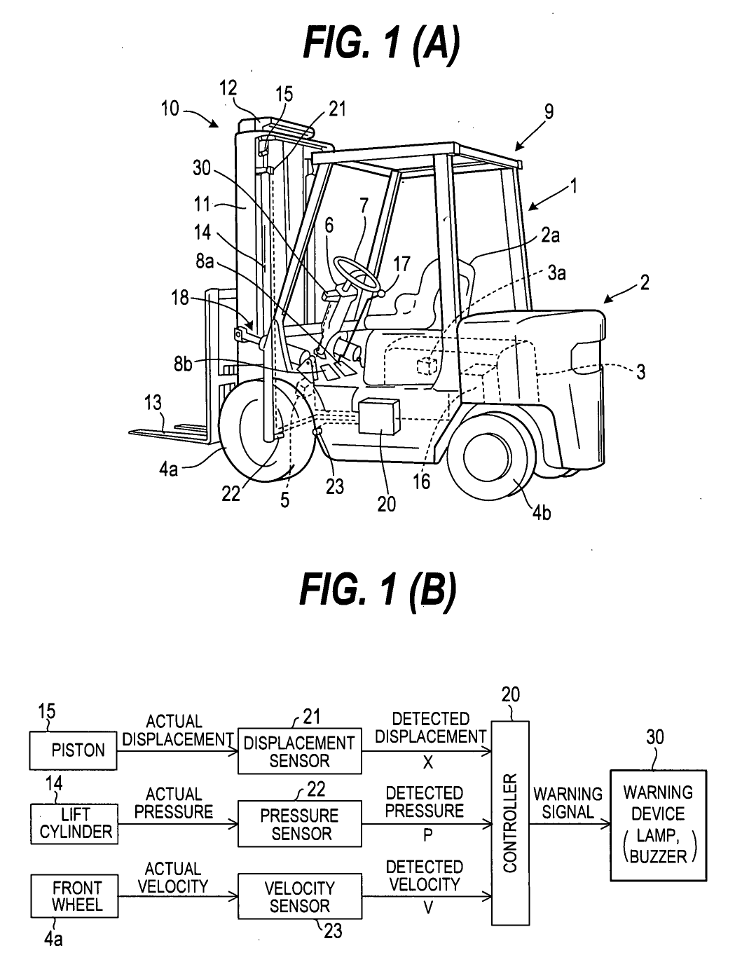

FIG. 1 explains the first embodiment.

At first, the whole structure of a forklift vehicle is explained. The forklift vehicle 1 comprises a vehicle body 2 in which a diesel type engine 3 as a driving device is installed. An output control device 3a is attached to the engine 3. Driving force of the driving device is transmitted to front wheels 4a through a gear mechanism (not shown). Rear wheels 4b are steered wheels so that driving force is not transmitted thereto. A braking device 5 is adapted for the front wheels.

An operator seat 2a is arranged at an upper middle portion of the vehicle body 2. A steering 7 attached to a steering support member 6 is provided in front of the operator seat 2a. An acceleration pedal 8a and a braking petal 8b are provided adjacent to a root portion of the steering support member 6. In order to protect an operator sitting on the operator seat 2a, a protective member 9 formed by four vertical support columns and an upper frame attached to each upper end of the respective vertical support column are provided. The acceleration pedal 8a is directly connected to the output control device 3a of the engine 3. The braking pedal 8b is connected to a breaking device 5 through a hydraulic circuit (not shown).

A lifting device 10 is mounted at the front end of the vehicle body 2. The lifting device 10 is an general structure and comprises an outer mast 11 mounted at the vehicle body 2, an inner mast 12 capable of vertical moving with respect to an outer mast and a fork 13 mounted at the inner mast 12 and movable along a vertical direction.

The inner mast 12 is moved upwardly/downwardly by a piston 15 actuated by a hydraulic cylinder 14 of the inner mast 12. A pulley (not shown) is provided at an upper end of the inner mast 12 and a chain pass though an upper groove of pulley. One end of the chain is fixed at the fork 13 and the other end is fixed at the outer mast 12. By moving the inner mast upwardly/downwardly, the fork 13 can be moved at a double elevation velocity of that of the inner mast 12. The inner mast 12 can be inclined by a tilt device 18.

A hydraulic control mechanism controlled by hydraulic oil in a lift cylinder 14 is attached at an inner side of the vehicle body 2. The hydraulic control mechanism 16 is controlled by a lift lever 17 which is operated by an operator. The hydraulic control mechanism 16 also supplies hydraulic oil to the tilt device 18.

In the next, specific tools for the first embodiment will be explained. At first, a displacement sensor 21 for detecting a displacement of the piston 15 is provided at an upper end of the lift cylinder 14. Beyond the lift cylinder 14, a pressure sensor 22 for detecting pressure in the lift cylinder is provided. A velocity sensor 23 for detecting revolution number of a front wheel 4a is provided at a portion of the vehicle body 2 adjacent to the front wheel 4a. Each sensor is connected to a controller 20 attached at the vehicle body 2. A warning device 30 is attached to the steering support member 6. The warning device 30 is also connected to the controller 20.

FIG. 1(B) explains signals transmitted to/from tools as described above.

The displace sensor 21 detects a displace of the piston 15 and a detected displacement X is transmitted to the controller 20. The pressure sensor 22 detects a pressure value of the lift cylinder and a detected pressure value P is transmitted to the controller 20. The velocity sensor 23 detects velocity (revolution number) of the front wheel 4a and detected velocity is transmitted to the controller 20. A warning signal is transmitted from the controller 20 to the warning device 30.

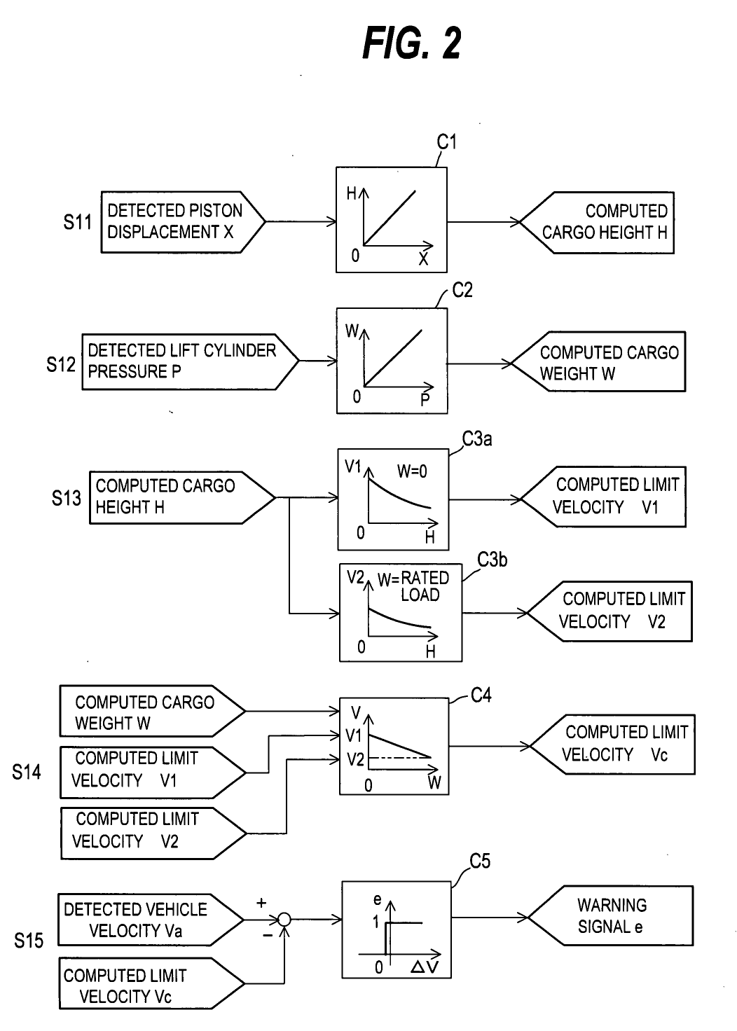

FIG. 2 explains a control system of the tools arranged above.

In a step S11, a detected piston displacement X is input to a computer C1 (memorized in the controller 20) so as to output a cargo height H. A height of a center of a gravity point of load on the fork 13 is varied depending on actual load. Therefore, a constant virtual height is obtained with respect to the fork 13.

In a step S12, load weight W is calculated by inputting lift cylinder pressure P into a computer C2 for outputting load weight W based on lift cylinder pressure P (memorized in the controller 20).

In a step S13, a computer C3a, which memories a relation of the cargo height H computed in the step S11 and a limit velocity in the case of non load condition (memorized in the controller 20), inputs the cargo height H and outputs a limit velocity V1 in the case of non load. A computer C3b, which memories the cargo height H output in the step S11 and a limit velocity V2 in the case of specified load (=maximum load), inputs the cargo height H and outputs a limit velocity V2 in the case of the specified load (=non load) condition. The limit velocity V1 and the limit velocity V2 indicates an overturning velocity in the case that a steering is fully turned so as to curve with the minimum turning radius, respectively. Therefore, the controller 20 memories the respective minimum turning radius corresponding to each limit velocity.

In a step S14, load weight W detected in a step S12 and the limit velocity V1 in the case of non load condition and the limit velocity V2 in the case of the specified load detected in the step S13 are input to a computer C4, which calculates linearly interpolation (memorized in the controller 20), the computer C4 outputs a limit velocity V_{c} in the case of the load weight W.

In a step S15, a velocity difference ΔV which is a detected value Va of a vehicle velocity detected by a velocity sensor 23 minus the limit velocity Vc detected in the step S14 is input to a computer C5 (memorized in the controller 20). If the velocity difference ΔV is positive (larger than 0), a warning signal for warning is output. In accordance with the warning signal, the warning device 30 sounds warning buzzer or lights an warning lamp so as to notify over velocity for an operator.

The first embodiment has a structure as described above and is operated as described above. In the case that vehicle velocity Va is faster than limit velocity Vc, the warning device makes warning with respect to an operator. An operator decelerates the vehicle in accordance with warning. In addition to other overturning prevention operations, the vehicle can be prevented from overturning. Even if a steering angle is increased, the vehicle is not overturned. Because the limit velocity V_{c} is calculated based on the minimum turning radius.

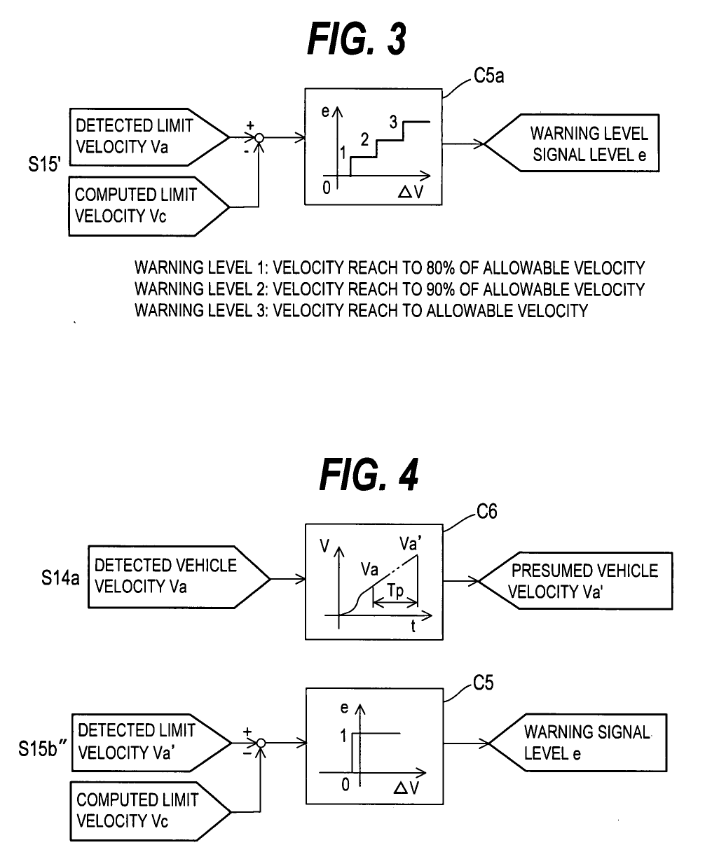

In the next, the first modified example of the first embodiment will be described. In the first modified example, warning sounds gradually. Instead of the step S15 of the first embodiment, a step S15′ as shown in FIG. 3 is operated. In the step S15′, a difference ΔV is detected based on the limit velocity Vc as detected velocity V in the step S14. In accordance with the difference ΔV, warning sounds gradually.

For example, the controller 20 memories a computer C5a instead of the computer C5. The computer C5a outputs a warning signal e1 as the first warning level at a moment when the difference ΔV reaches 80% of the limit velocity Vc. When the difference ΔV reaches 90% of the limit velocity Vc, a warning signal e2 corresponding to the second warning level is output. When the difference ΔV becomes 100% of the limit velocity V_{c}, a warning signals e2 corresponding to the third warning level is output.

The first embodiment has the above structure and warning levels are changed at multi-steps so that an operator can avoid for overturning sufficiently.

In the next, the second modified example of the first embodiment will be described. In the second modified example of the first embodiment, it is presumed presumption vehicle velocity Vₐ′ at a moment after a predetermined time period from the present time judging from the present vehicle velocity Va. Upon comparing with the presumption vehicle velocity Vₐ′ and the limit velocity V_{c}, warning is occurred in the case that the presumption vehicle velocity Vₐ′ is larger than the limit velocity V_{c}.

In the next step of the step S14 of the first embodiment, the computer C6 (memorized in the controller 20) presumes velocity Vₐ′ judging from the present vehicle velocity in a step S14a as shown in FIG. 4. In a step S15, a difference ΔV between the presumption vehicle velocity Vₐ and the limit velocity Vc detected in the step S14 is detected. Then, the difference ΔV is input to the computer C5. If the difference ΔV is positive (greater than zero), warning signal (warning occurrence command) is transmitted to the warning device 30.

The second modified example of the first embodiment has a structure as described above and is reached as described above. Before vehicle velocity is reached to the limit velocity, warning is occurred so that an operator can be prevent the vehicle from being overturned the vehicle sufficiently.

In the next, the second embodiment will be described. As similar as the first embodiment, the second embodiment detects limit velocity Vc and compares the limit velocity Vc and the present vehicle velocity V. If the present vehicle velocity is over the limit velocity Vc, a height of a load is reduced and power increase is saved.

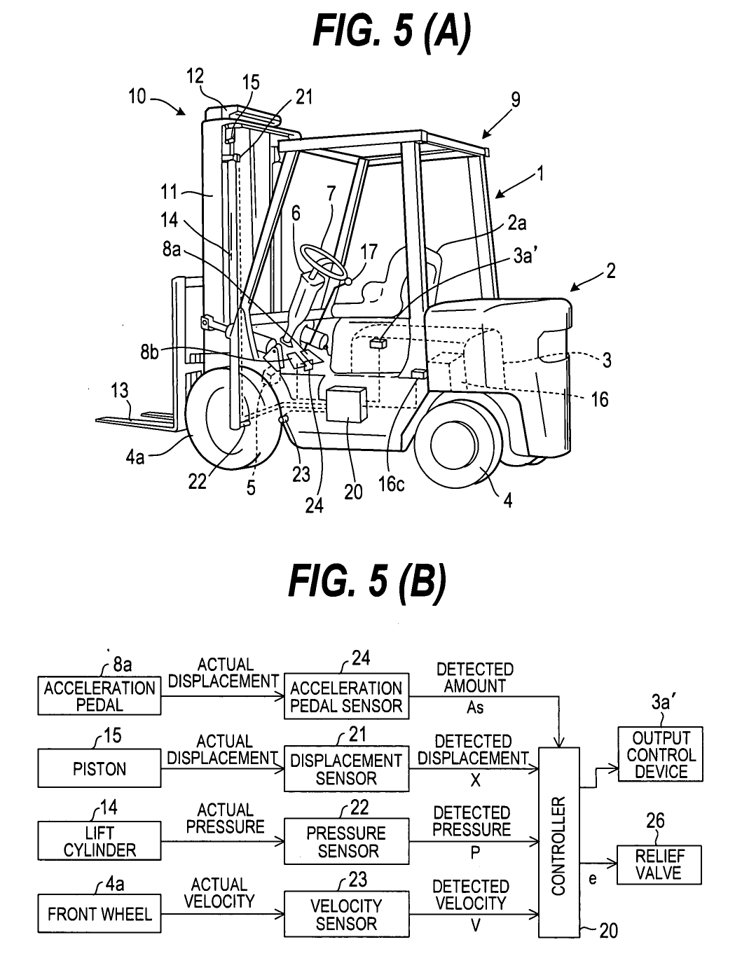

FIG. 5(A) shows a structure of the second embodiment. A basic structure thereof is same to that of the first embodiment so that a description thereof is omitted. As similar as the first embodiment, a displacement sensor 21, a pressure sensor 22 and a velocity sensor 23 are provided.

Although the first embodiment employs an acceleration pedal 8a and an output control device 3a for an engine mechanically connected to the acceleration pedal 8a, the second embodiment employs an acceleration pedal sensor 23 for detecting a stepping degree of the acceleration pedal 8a wherein the acceleration pedal sensor 23 is provided beyond the acceleration pedal 8a and connected to the controller 20. On the other hand, an output control device 3a′ has an electronic control actuator (not shown), the actuator adjusts output in accordance with an signal transmitted from the controller 20.

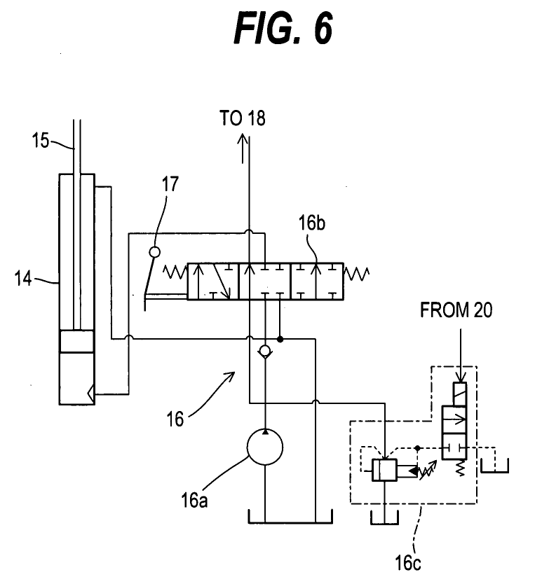

A hydraulic control device 16 for feeding hydraulic oil to a lift cylinder 14 has a relief valve 16c. FIG. 6 shows the hydraulic control device 16 and the relief valve 16c. The hydraulic control device comprises a pump 16a, a switch valve 16b connected to a lift lever. In addition, the second embodiment further comprises the relief valve 16c.

FIG. 5(B) explains signals transmitting to/receiving from tools in the second embodiment. As similar as the first embodiment, a displace amount of a piston 15 is detected by a displacement sensor 21 and the detected displacement X is transmitted to a controller 20. A pressure sensor 22 detects pressure applied to a lift cylinder and detected pressure P is transmitted to the controller 20. A velocity sensor 23 detects velocity (rotational velocity) of a front wheel 4a. The data of the detected velocity V is transmitted to the controller 20. In the second embodiment, the pedal sensor 24 detects the stepping amount As of the acceleration pedal 8a and the detected data is transmitted to the controller 20.

Then, as described below, the controller 20 output control signal to an output control device 3a′ and a relief valve 16c.

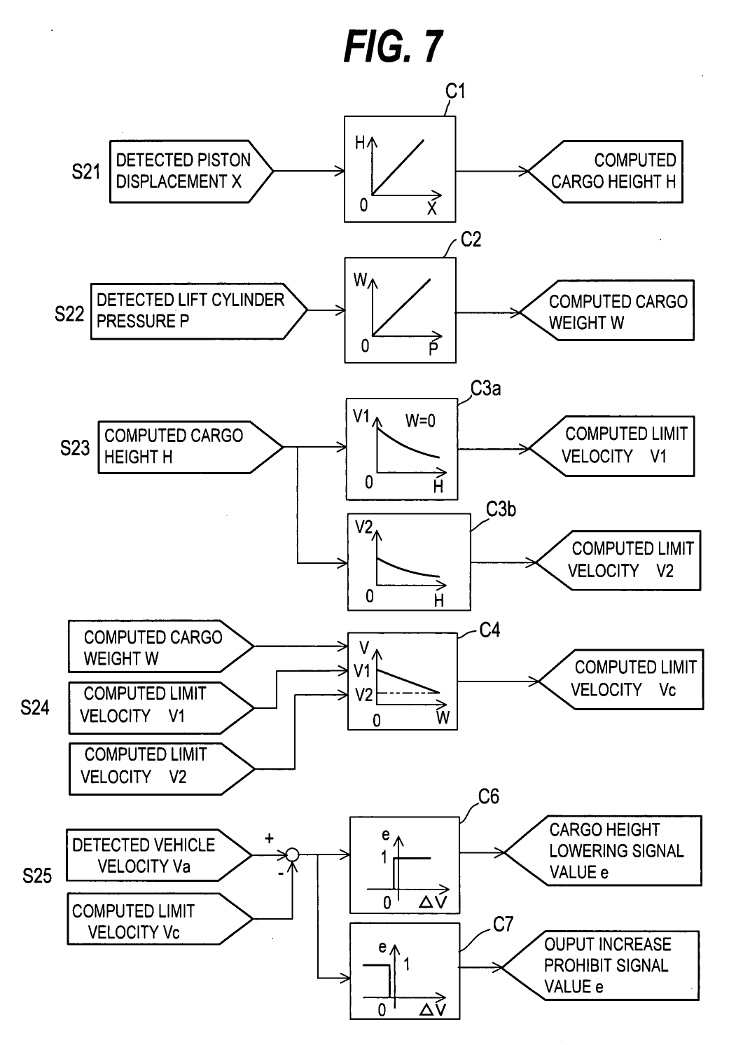

FIG. 7 shows a structure of the second embodiment as descried above and explains an operation thereof.

Concerning with the steps S21 through S24, these step are the same of the first embodiment. Therefore, we omit these descriptions. In a step S25, a velocity difference ΔV that is subtracted the limit velocity Vc detected in the step S14 from the detected velocity Va is detected. In the case that the velocity difference ΔV is positive (greater than zero), the relief valve 16c of the hydraulic control device 16 is opened in accordance with the computer C6 (memorized in the controller 20) so to lower a cargo height. Simultaneously, even if a signal from the acceleration pedal sensor 24 demands on increasing output in accordance with the computer C7 (memorized in the controller 20), such a demand is not transmitted to the output control device 3a′ so as to suppress output increase and prohibit velocity increase.

A structure of the second embodiment has a structure as described above and operates in accordance with the above process. When vehicle velocity Va is reached to the limit velocity Vc, cargo height becomes lower and vehicle velocity is suppressed in order to avoid for being overturned.

In the next, a modified example of the second embodiment will be described.

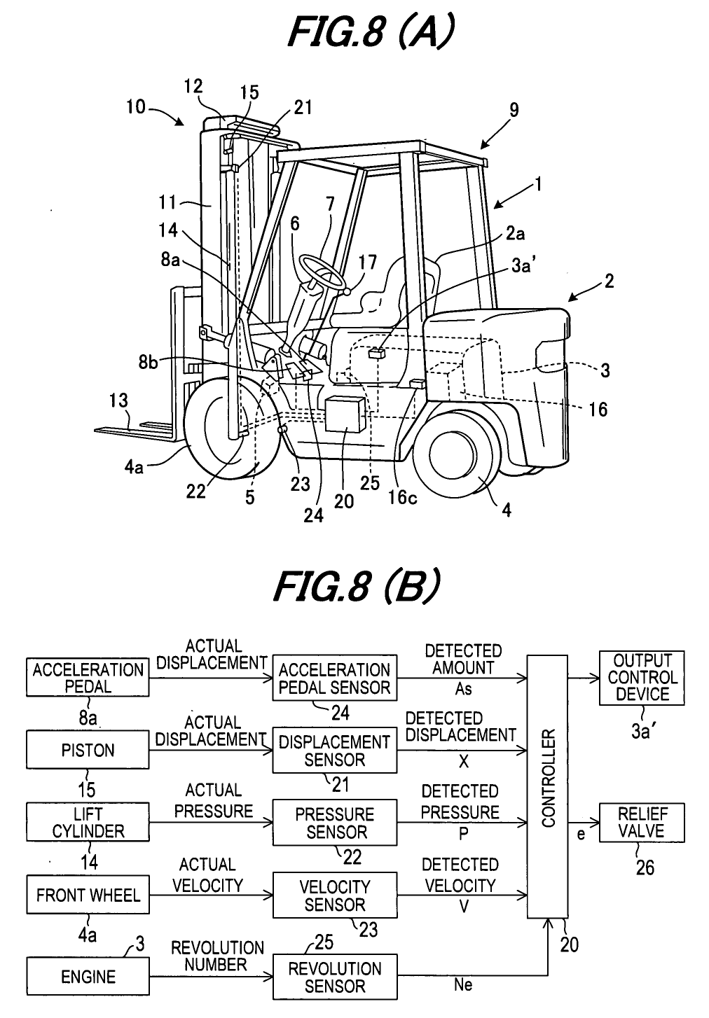

FIG. 8(A) shows a modified example of the second embodiment. As similar as the second embodiment, the modified example comprises a displacement sensor 21, a pressure sensor 22, a velocity sensor 23 and an acceleration pedal sensor 24, and further comprises engine revolution number sensor 25. An output control device 3a′ is as similar as that of the second embodiment.

Even if a demand for increasing output from the acceleration pedal sensor 24 is output, the output control device 3a′ controls a governor (centrifugal spark advancer) so as to maintain the present output level. FIG. 8(B) shows signals transmitting to/receiving from the tools.

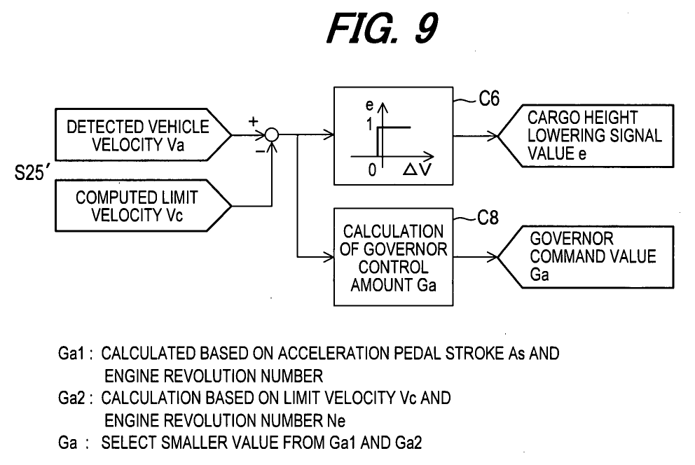

Instead of the step 25 in the second embodiment, a step 25′ as shown in FIG. 9 is operated. In the step 25′, as similar as the second embodiment, the computer C5 outputs a signal for lowering cargo height and a computer C8 (memorized in the controller 20) decides control amount Gₐ for the governor. For example, in accordance with an acceleration pedal stroke As and engine revolution number, a corresponding control amount Gₐ is decided with respect to the present output demand. In accordance with limit velocity V_{c} and an engine revolution number, a control amount Ga1 is also decided with respect to the present output demand. In accordance with the limit velocity V_{c} and the engine revolution number, a control amount Ga2 is calculated with respect to the limit velocity V_{c}. Upon comparing with the control amount Ga1 and the control amount Ga2, a smaller amount is selected.

The modified example of the second embodiment has the structure as described above and is operated as described above. When a vehicle velocity Vₐ is increased to the limit velocity V_{c}, a cargo height is lowered and the vehicle velocity Vₐ is not increased so as to prevent from being overturned.

In the next, the third embodiment will be described. In the third embodiment, an actual rolling moment is detected and compared with a limit rolling moment previously memorized. In the case that the actual rolling moment is over the limit rolling moment, vehicle velocity is decelerated by a braking device so as to become the actual rolling moment less than the limit rolling moment.

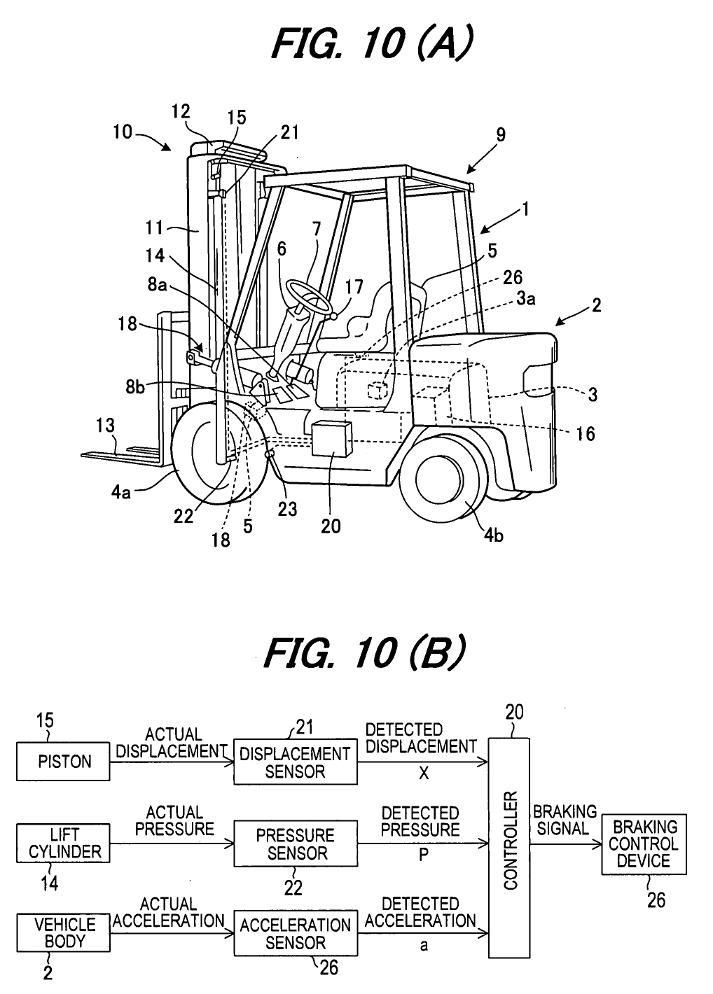

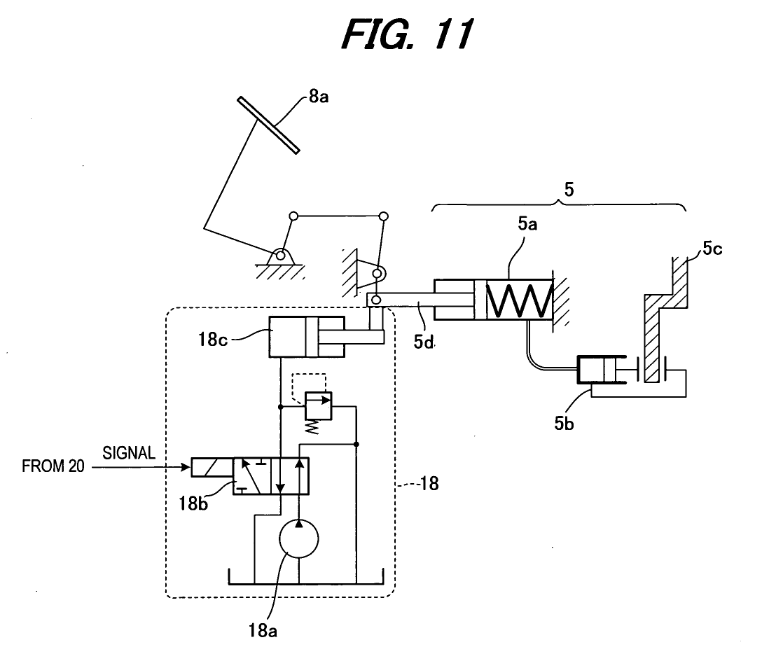

FIG. 10(A) shows a structure of the third embodiment. The third embodiment utilizes control devices, that is, a displacement sensor 21 employed in the first and second embodiments, a pressure sensor 22 and an acceleration sensor 26 mounted beyond a seat 2a for detecting acceleration in a lateral direction. A braking control device 18 is provided at a braking device 5. FIG. 10(B) explains signals transmitted to/received from the devices as described above.

FIG. 11 shows a model of the braking control device 18 with the braking device 5. The braking device 5 comprises a braking disc 5a, calipers 5b for pressing friction material on the braking disc 5a and a master cylinder 5c for transmitting operational force actuated by the braking pedal 8a onto the braking disc 5a by transferred to hydraulic force.

The braking device 18 transmits hydraulic pressure occurred in a hydraulic pump 18 to a cylinder 18c through an electromagnetic switch valve 18b and actuate a piston 5d of the master cylinder 5c by a piston 18d moved in the cylinder 18c. Then, a signal is transmitted to the electromagnetic switch valve 18b from the controller 20.

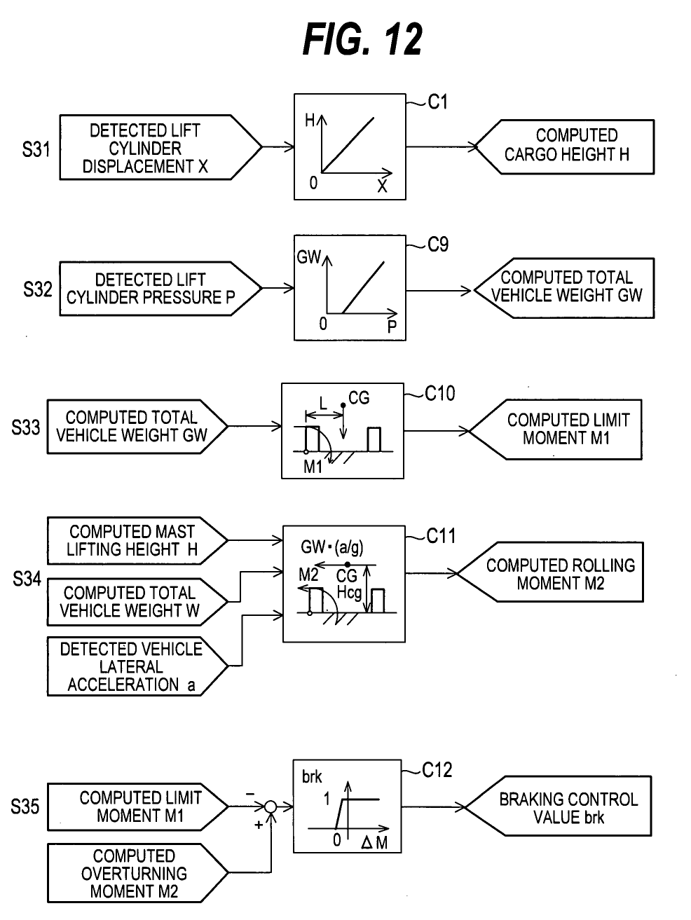

FIG. 12 explains a control system of the third embodiment. A step S31 is as same as the step S11 in the first embodiment. In a step S32, the total vehicle weight GW is calculated from a value P detected by the pressure sensor 22 and the computer C9 (memorized in the controller 20). In a step S33, a limit moment M1 is detected based on the total vehicle weight GW and the computer C10. Practically, the computer 10 multiplies the total vehicle weight GW by a distance L between a central gravity point CG and an outer peripheral edge of a front wheel 4a so as to detect the limit moment M1. The distance L and the central gravity point CG are aligned on a centerline with respect to a lateral direction of a vehicle body 2. A distance between the centerline and the outer peripheral edge is already unchanged so that the distance L is memorized as a determined value in the controller.

In a step S34, a rolling moment M2 is calculated based on the cargo height H detected in the step S31, the total vehicle weight GW, the lateral acceleration a detected by the acceleration sensor 26 and the computer C11 (memorized in the controller 20). Practically, a height H_{CG} from the ground level to the central gravity point CG is detected. The height H_{CG} is multiplied by the total vehicle weight GW and a value that the lateral acceleration a is divided by gravity acceleration g so as to detect the rolling moment M2.

In a step S35, the limit moment M1 detected in the step S32 and the rolling moment M2 detected in a step S34 are compared. In the case that the limit moment M1 is less than the rolling moment M2, a command for actuating the braking device 5 is output to the brake control device 18 so as to control the limit moment M2 greater than the rolling moment M2.

The third embodiment has the above structure and operated as described above. In order to prevent for the vehicle from being overturned, the braking device 5 is actuated so as to prevent the rolling moment from being greater than the limit moment M1.

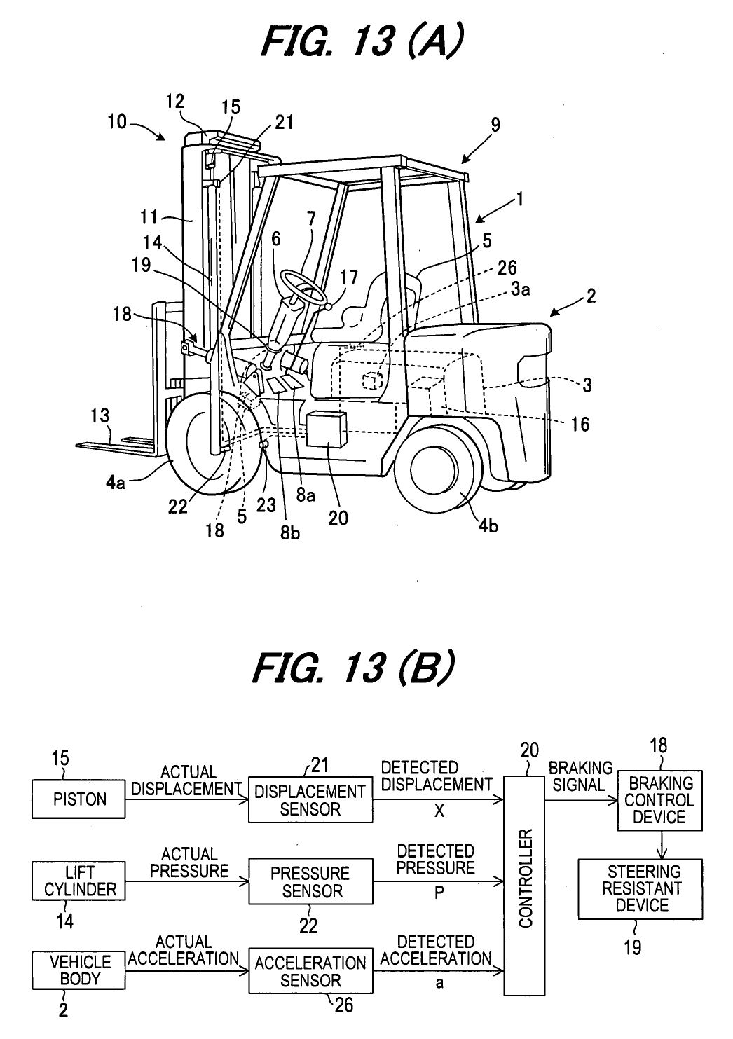

In the next, the first modified example of the third embodiment will be described. The example comprises a steering resistant device 19 for controlling rotations of a steering 7. If the limit moment M1 is less than the rolling moment M2, the steering resistant device 19 controls the steering 7 not to increase a steering angle. FIG. 13(A) shows a structure of the first modified example of the third embodiment. Upon comparing with the third embodiment, it is only different that the steering resistant device 19 is provided. FIG. 13(B) explains signals transmitting to/received from the devices in the first modified example of the third embodiment.

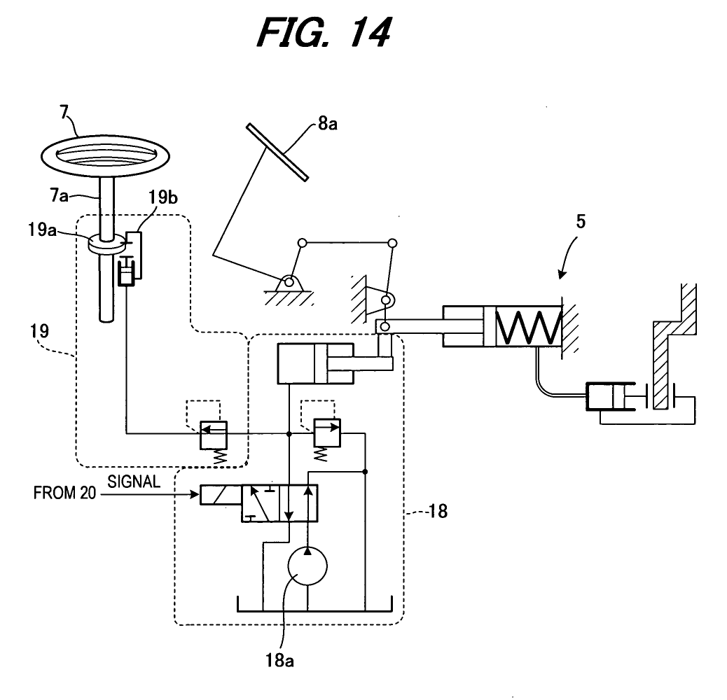

FIG. 14 shows a model of a steering resistant device 19. The steering resistant device 19 is belonged to a kind of a braking device comprising a disc 19a fixed to a steering axis 7a and calipers 19b for pressing a friction board onto the disc 19a. Hydraulic oil pressurized in a pump 18a of the braking control device 18 is supplied to the calipers 19b.

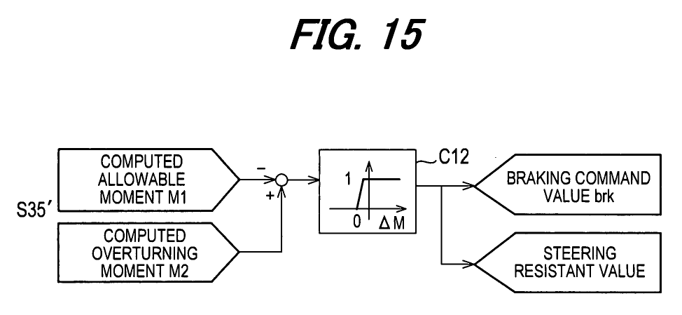

Then, instead of the step S35 of the third embodiment, it is operated a step 35′ as shown in FIG. 15. In addition to the step S35 of the third embodiment, a step 35′ as shown in FIG. 15 further comprises an output of a steering resistant command value in the case that the limit moment M1 is less than the rolling moment M2.

In the next, the second modified example of the third embodiment will be described. In the second modified example of the third embodiment, a presumption lateral acceleration a′ after few moments from the present time is presumed in accordance with the present lateral acceleration a of a vehicle. Upon comparing the presumption vehicle velocity Vₐ′ and the limit velocity V_{c}, the steering resistant device 18 is actuated in the case of the presumption vehicle velocity Vₐ′ greater than the limit velocity V_{c}.

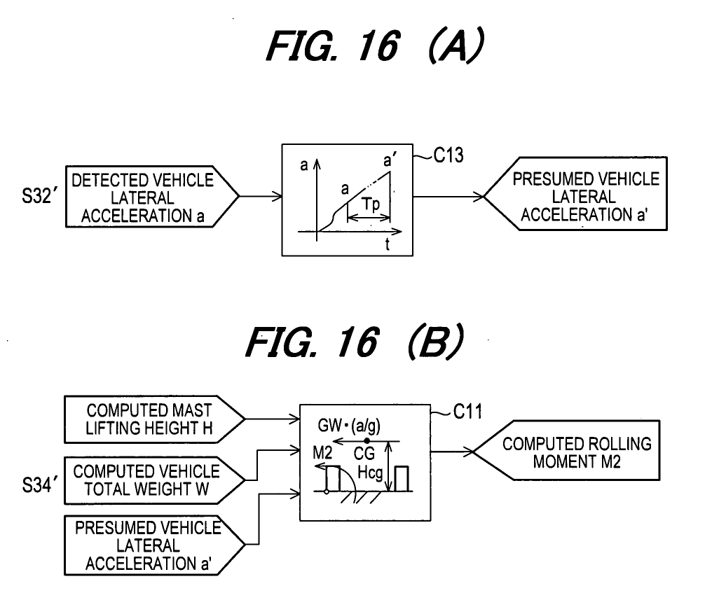

In the next of the step S32 of the third embodiment, the step S32′ as shown in FIG. 16(A) detects a lateral acceleration a′ after few moments from the present moment by considering the present lateral acceleration a in the computer C13 (memorized in the controller 20). Instead of the step S34, the lateral acceleration a′ presumed in the step S34′ as shown in FIG. 16(B) by the computer C11 is utilized to calculate a overturning moment M2.

The second modified example of the third embodiment has the above structure and is operated as described above. Upon comparing with respect to the third embodiment, a control operation of the second modified example can be started earlier and the control operation is more safety and prevents for the vehicle from being overturned within a short time.

In the next, the fourth embodiment will be described.

As similar as the third embodiment, the fourth embodiment detects the overturning moment and maintains the overturning moment within an allowable range. However, it is different from the overturning moment calculated from a yaw rate of a vehicle (=yaw acceleration) and a wheel steering angle.

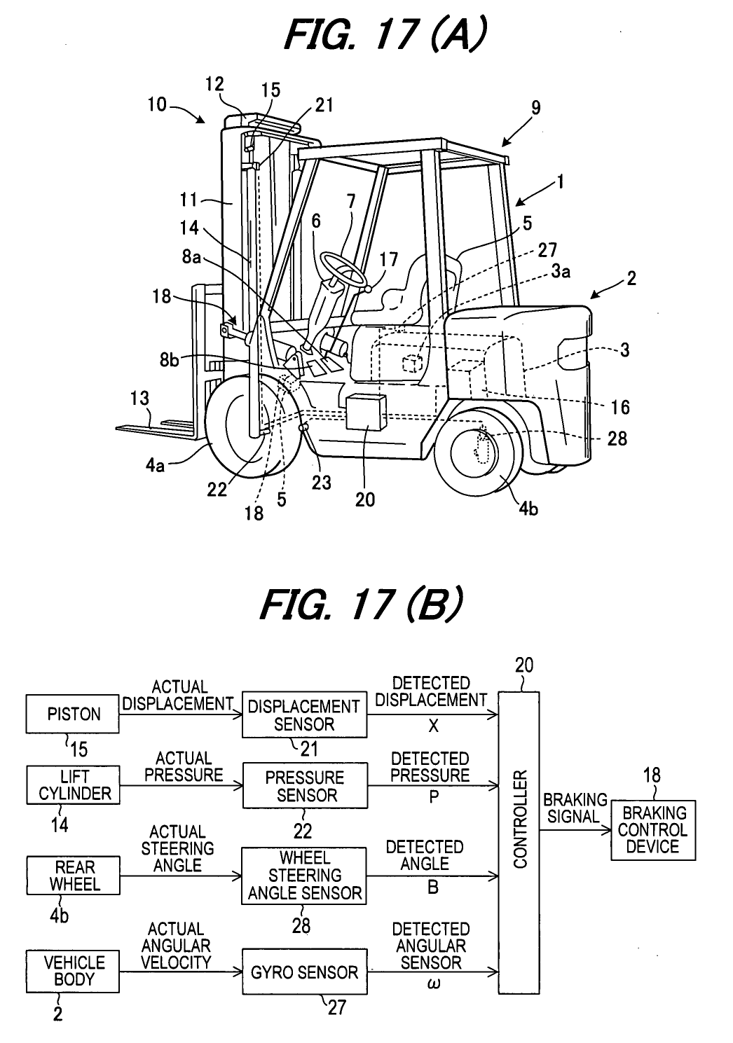

FIG. 17(A) shows the fourth embodiment. The fourth embodiment comprises a displacement sensor 21, a pressure sensor 22, a gyro sensor 27 mounted beyond the seat 2a and for detecting a rate of rotation of the vehicle body 2 and a wheel steering angle sensor 28 attached to a rear wheel 4b and for detecting a vehicle condition. In accordance with such a result, velocity is controlled by the braking control device 18 attached to the braking device 5.

FIG. 17(B) explains signals transmitting to/received from the tools as described above.

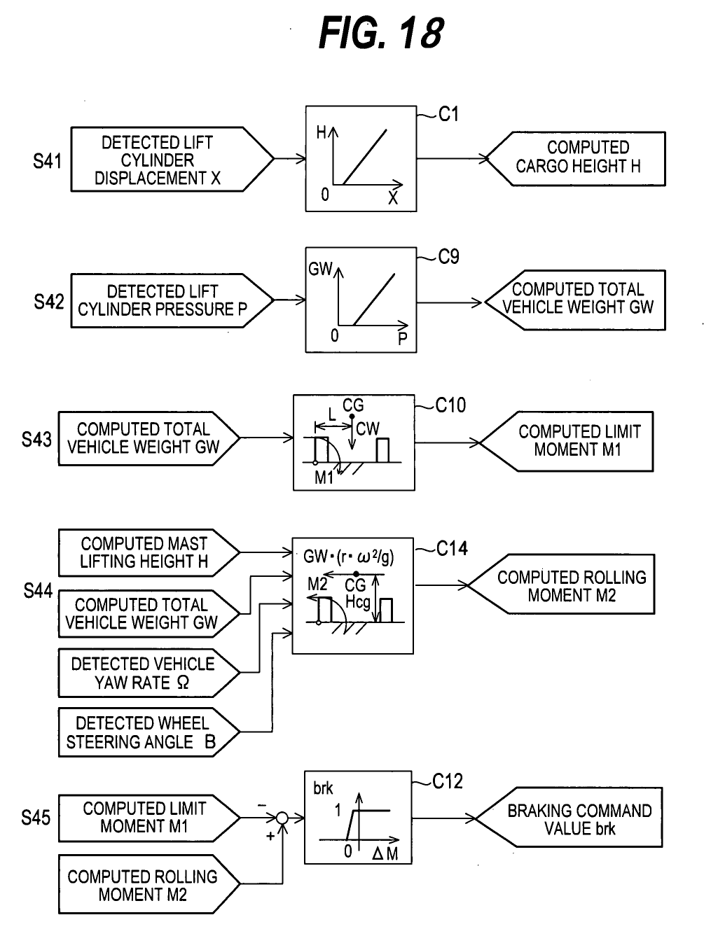

FIG. 18 explains a control operation of the fourth embodiment. Steps S41 through S43 of the fourth embodiment are as same as the steps S31 through the step S33. Therefore, an explanation thereof is omitted. In a step 44, a rolling moment M2 is detected by a controller C24 (memorized in the controller 20) in accordance with a cargo height H detected in the step S41, a total vehicle weight GW detected in a step S42, a vehicle yaw rate ω detected by the gyro sensor 27 and a wheel steering angle βdetected by the wheel steering sensor 28.

Herein, a calculation of the computer C14 will be described. The rolling moment M2 is a moment (force×arm length) of which a center point is a contact point of an outer peripheral edge with respect to the ground. The arm length of the moment is a height H_{CG} of the gravity point CG that is detected from the cargo height H detected in the step S41. Lateral acceleration r ω² for occurring the moment force is detected from a rotation radius r and the vehicle yaw rate ω. The rotation radius r is calculated based on the wheel steering angle β and the vehicle yaw rate ω is detected by the gyro sensor 27.

In the step S35, the computer C12 compares the limit moment M1 detected in the step S32 and the rolling moment M2 detected in the step 34. If the limit moment M1 is less than the rolling moment M2, a barking command is output to the break control device 18 so as to become the rolling moment M2 less than the limit moment M1.

The fourth embodiment has a structure as described above and is operated as described above. As similar as the third embodiment, an overturning phenomenon is prevented by actuating the breaking device 5 to control the rolling moment M2 less than the limit moment M1.

In the next, a modified example of the fourth embodiment will be described. In the first modified example of the fourth embodiment, a presumption steering angle β′ at a moment after the predetermined time period from the present time is presumed judging from the present steering angle β. The rolling moment M2′ at a moment after the predetermined time period from the present time is calculated based on the presumption steering angle β′. The rolling moment M2′ at the moment after the predetermined time period is compared to an allowable rolling moment M1. Depending on such a result, the braking control device 18 is actuated.

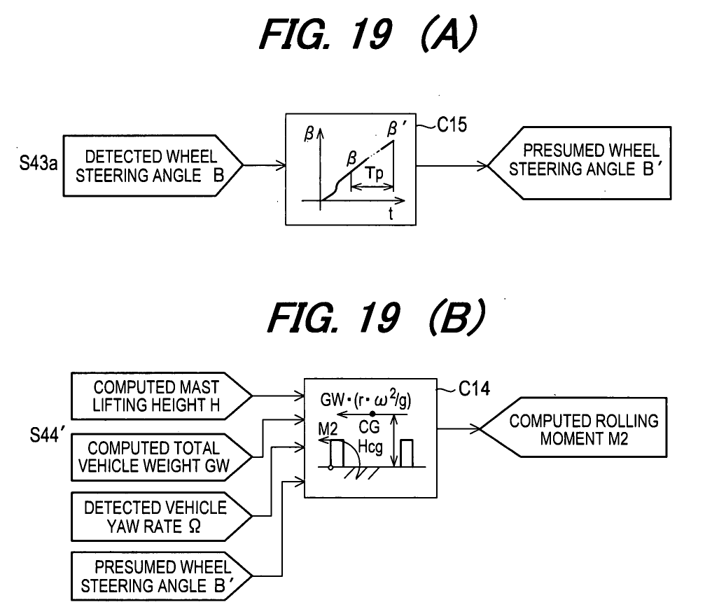

In the next of the step S43 of the fourth embodiment, in a step S43a as shown in FIG. 19(A), a wheel steering angle β′ at a moment after the predetermined time period from the present time is calculated by considering the preset wheel steering angleβ in the computer C15 (memorized in the controller 20). By utilizing the lateral acceleration a′ presumed in the step S44′ as shown in FIG. 19(B) instead of the step S44, the computer C11 detects the rolling moment M2 based on the lateral acceleration a′ presumed in the computer C11. As similar as the fourth embodiment, the step S45 is operated.

The modified example of the fourth embodiment has a structure and is operated as described above. Comparing with respect to the fourth embodiment, controlling timing becomes earlier and an overturning phenomenon can be avoided within a short time.

In the next, the fifth embodiment will be described. In the fifth embodiment, the vehicle body 2 is braked and resistant force is applied to the steering 7 under the condition that the running velocity Vₐ is over the limit velocity V, and rotational velocity of the steering 7 is over the predetermined value.

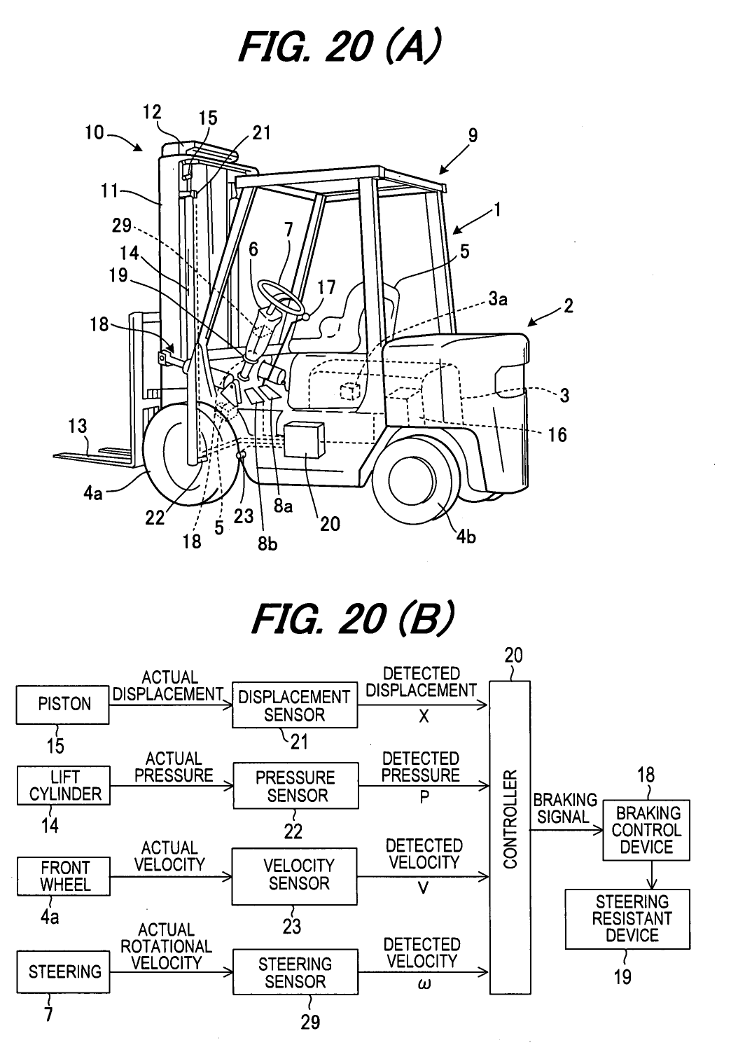

FIG. 20(A) shows a structure of the fifth embodiment. As similar as the first embodiment, the fifth embodiment comprises a displacement sensor 21, a pressure sensor 22 and a velocity sensor 23. Further, the fifth embodiment comprises a steering sensor 29 for detecting rotational velocity of the steering 7 at a steering supporting member 6. As similar as the first modified example of the third embodiment, the fifth embodiment comprises the braking control device 18 and the steering resistant device 19. FIG. 20(B) explains signals transmitting to/received from the devices as described above.

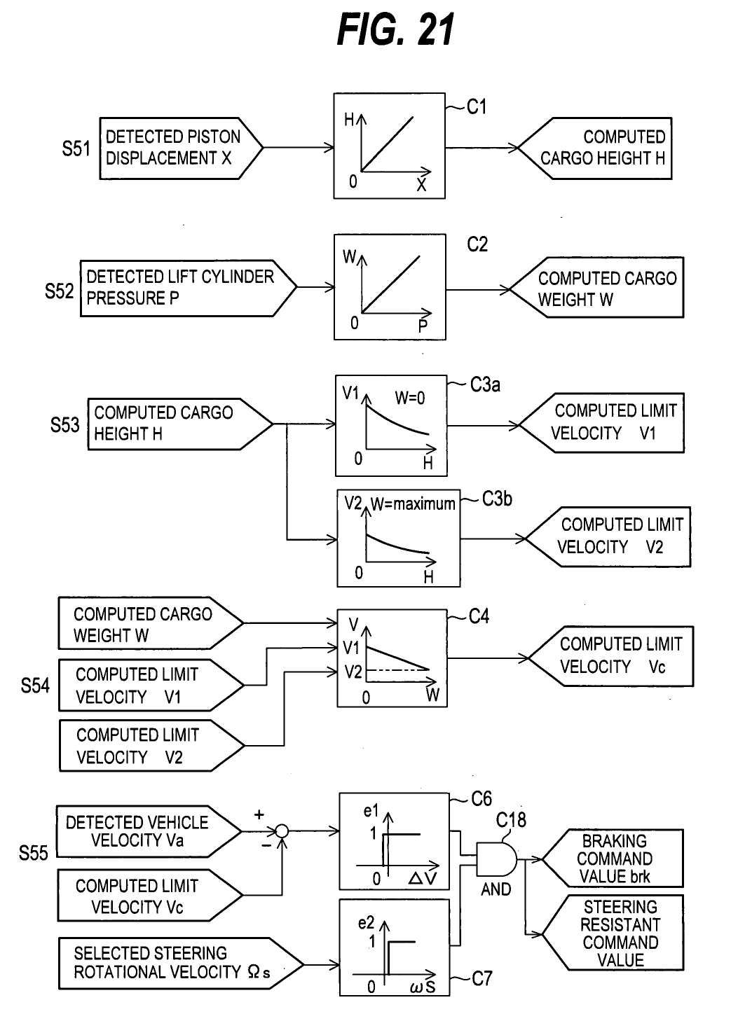

FIG. 21 explains a control operation of the fifth embodiment. Steps S51 through S54 are as same as the steps S11 through S14 of the first embodiment. Therefore, the explanation thereof is omitted. In a step S55, a computer 16 (memorized in the controller 20) outputs an ON signal in the case that a difference ΔV (a vehicle velocity computed value Vₐ minus a limit velocity V_{c}) is positive. A computer 17 (memorized in the controller 20) outputs a ON signal in the case that a steering rotational velocity ωs is over a predetermined value. When the both of the computers 16 and 17 outputs an On signal, respectively, a braking command value and a steering resistant command value are transmitted to the braking control device 18 and the steering resistant device 19 through the AND circuit 18.

In the fifth embodiment, if a vehicle velocity Va is reached to the limit velocity V_{c} and a steering velocity ωs is over the predetermined value, the vehicle body 2 is braked and the steering 7 is controlled not to occur a overturning phenomenon.

Although the embodiments including the first embodiment through the fifth embodiment are explained as described above, these embodiments can be partly or totally combined.

For example, as one example of the former case, instead of a prohibition for lifting up a cargo and increasing power in the second embodiment, the braking control device 16 in the fourth embodiment can be employed. As one example of the later case, after the warning device is actuated in the first embodiment, it may operate the braking control device 16 as similar as the fourth embodiment.

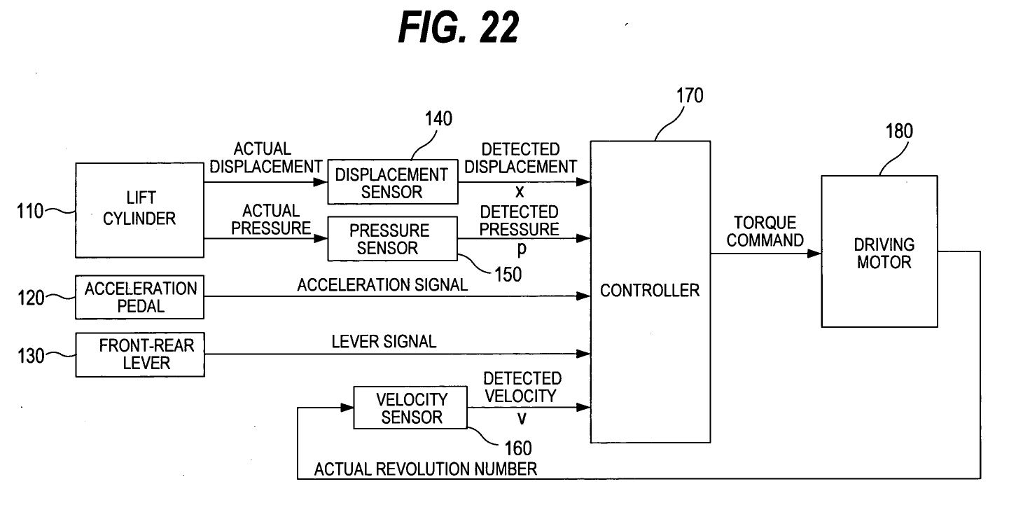

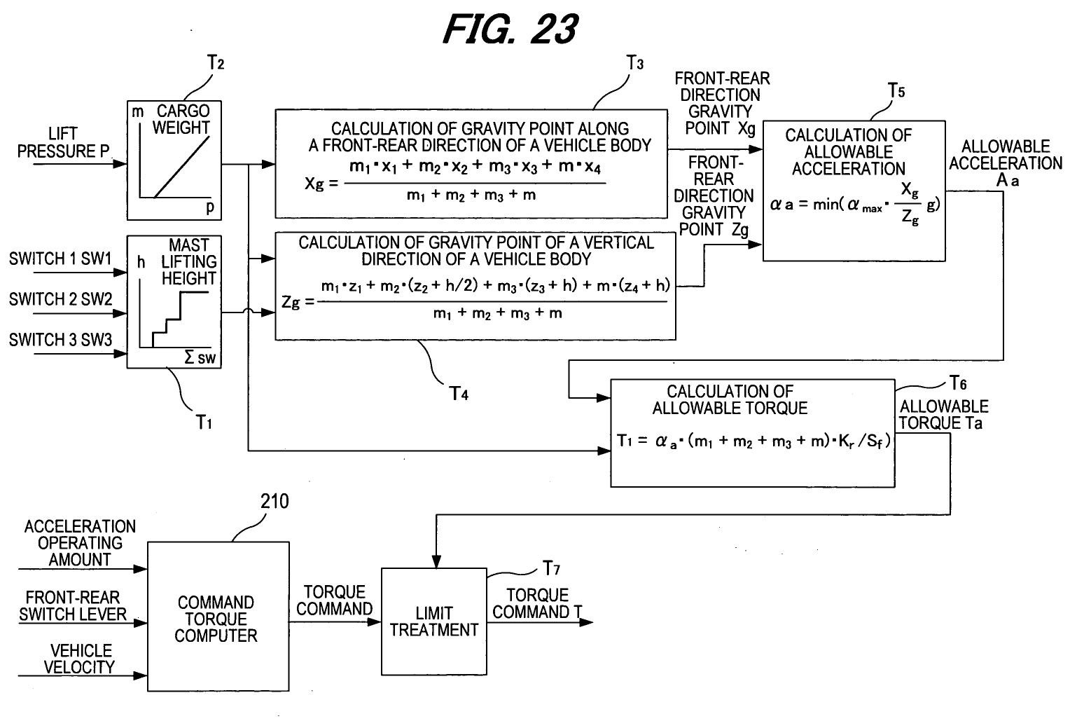

The sixth embodiment will be described with reference to FIG. 22 and FIG. 23. FIG. 22 is a system structure and FIG. 23 is a block diagram of an allowable torque treatment.

In the sixth embodiment, an allowable acceleration is presumed in accordance with a mast lifting height (cargo height) and lifting load and running torque is controlled in order to be the acceleration less than the allowable acceleration.

As shown in FIG. 22, the displacement sensor 140 detects an actual displacement of the lift cylinder and the pressure sensor 150 detects an actual pressure. Then, the detected displacement X and the detected pressure P are input to the controller 170. An acceleration signal is input from the acceleration 120 to the controller 170. A lever signal is input from a front-rear lever 130 to the controller 170. The velocity sensor 160 detects an actual rotational velocity of the driving motor 180. The detected velocity v is input to the controller 170.

In accordance with input signals, the controller 170 outputs a torque command to the driving motor 180. In accordance with the block diagram of the allowable torque treatment as shown in FIG. 23, the allowable acceleration is presumed and the running torque is controlled not to be over the allowable acceleration.

The block diagram of the allowable torque treatment as shown in FIG. 23 comprises a calculation of mast lifting height (step T1), a calculation of cargo load (step T2), a calculation of gravity point of the vehicle body along a front-rear direction (step T3), a calculation of a gravity point along a vertical direction of the vehicle (step T4), a calculation of an allowable acceleration (step T5), a calculation of an allowable torque (step T6) and a limit process (step T7).

### [Mast Lifting Height (Step T1)]

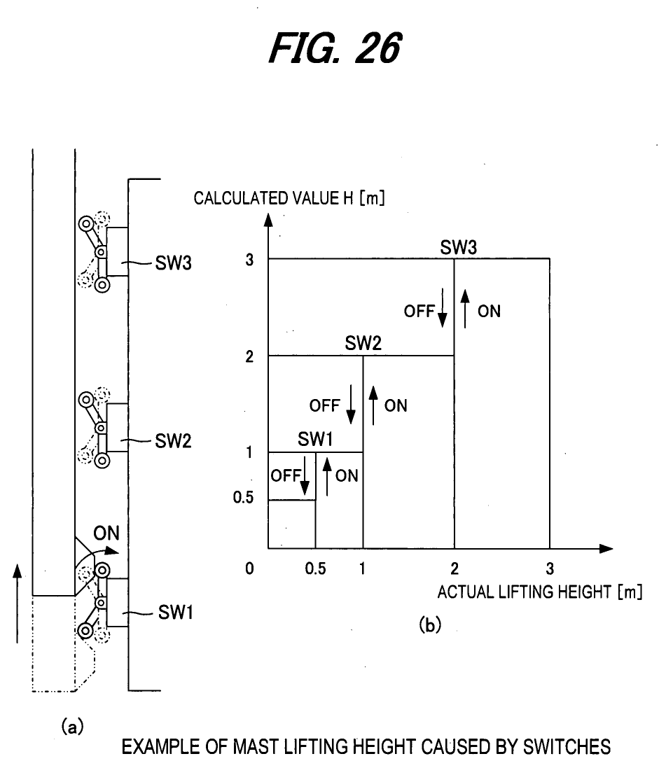

As shown in FIG. 26(a), a mast lifting height h(t) is detected by the displacement sensor 140 including three limit switches SW1, SW2 and SW3 (ON/OFF), wherein each limit switches detects three ranges (lower area, middle area and upper area), respectively. An equation for calculating the mast lifting height is shown in an equation (1).

h(t)=(0.5×SW₁(t)+1.5×SW₂(t)+SW₃(t))×1000 equation (1)

wherein;
t: time [sec]
h: mast lifting height (variable number) [mm]
SW₁: lower range switch (detected value, ON: 1, OFF: 0)
SW₂: middle range switch (detected value, ON: 1, OFF: 0)
SW₃: upper range switch (detected value, ON: 1, OFF: 0)

Accordingly, as shown in FIG. 26(b), if the actual lift height is greater than 0.0 m and less than 0.5 m, the height h is calculated as 0.5 m. If the actual lift height is greater than 0.5 m and less than 1.0 m, the height h is calculated as 1.0 m. If the actual height is greater than 1.0 m and less than 2.0 m, the height is calculated as 2.0 m. If the actual height is greater than 20 m and less than 3.0 m, the height is calculated as 3.0 m.

[Detection of Cargo Weight m (step T2)]

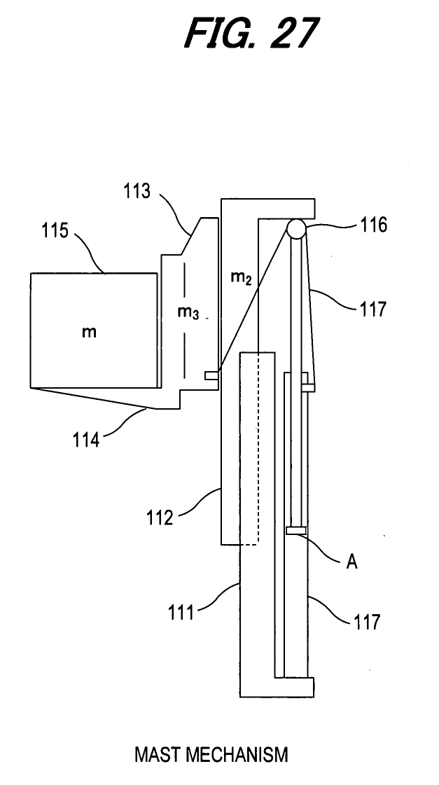

FIG. 27 shows a mast mechanism, wherein an inner mast 112 is attached to an outer mast 111 and movable along a vertical direction. A lift bracket 113 is attached to the inner mast 112 and movable along a vertical direction. A fork 114 on which cargo 115 is located is attached to the lift bracket 113 and horizontally protruded therefrom. The lift bracket 113 is connected to a chain 117 through a chain hole 116.

Accordingly, a lift pressure p of the lift cylinder 110 is detected by the pressure sensor 140 and a cargo weight m(t) is calculated. An equation for calculating the cargo weight m is shown in an equation (2).

m(t)={(p(t)×A)/g−m₂−2.0×m₃}//2 equation (2)

wherein;
m: cargo weight (constant) [kg]
p: lift cylinder pressure (detected value) [MPa]
A: area on where the lift cylinder pressure is applied (constant) [mm²]
g: gravity acceleration (constant) [m/S²]
m₂: inner mast weight (constant) [kg]
m₃: fork lift bracket weight (constant) [kg]

### [Calculation of Gravity Point X_{g} of a Vehicle Body Along a Front-Rear Direction (Step T3)]

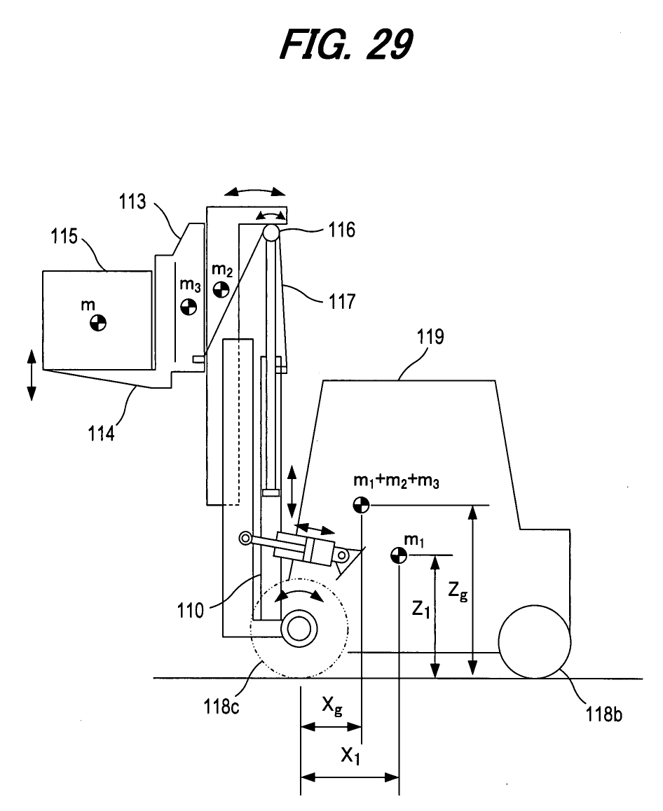

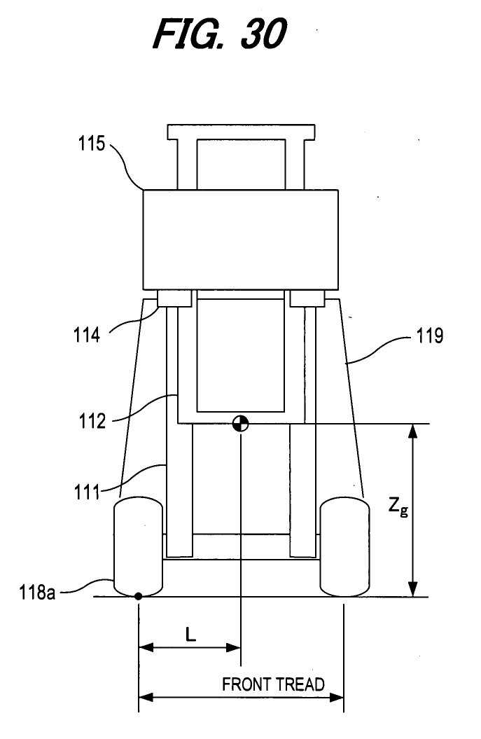

FIG. 29 and FIG. 30 show relations between the cargo weight m(t) and the mast lifting height h(t) and the gravity point Xg of the vehicle along the front-rear direction.

As shown in the both figures, a vehicle body 119 has front wheels 118a and rear wheels 118b. The mast mechanism is attached to a front portion of the vehicle body 119 and can be swung.

Accordingly, in accordance with the cargo weight m(t) mast lifting height h(t), the gravity point X_{g} of the vehicle body along a front-rear direction is calculated in an equation (4).

X_{g}(t)=(m₁·x₁+m₂·x₂+m₃·x₃+m(t)·x₄)/(m₁+m₂+m₃+m(t)) equation (4)

wherein,
X_{g}: gravity point of vehicle body along a front-rear direction (variable number) [mm]
m₁: vehicle body weight (constant) [kg]
m₂: inner mast mass (constant) [kg]
m₃: fork+lift bracket mass (constant) [kg]
m: cargo weight (displacement) [kg]
x₁: gravity point of a vehicle body along a front-rear direction (constant) [mm]
x₂: gravity point of inner mast along a front-rear direction (constant) [mm]
x₃: gravity point of the both of a fork and a lift bracket along a front-rear direction (constant) [mm]
x₄: gravity point of load along a front-rear direction (constant) [mm]
[Calculation of Gravity point Z_{g} of a Vehicle Body Along a Vertical Direction (Step T4)]

Relations between a cargo weight m(t), mast lifting height h(t) and the gravity point Zg of the vehicle body along a vertical direction are shown in FIG. 29 and FIG. 30. In accordance with the mast lifting height h(t) and the cargo weight m(t), the gravity point Zg of the vehicle body along a vertical direction is calculated in an equation (5)

Z_{g}(t)={m₁·z₁+m₂·(x₂+h(t)/2)+m₃·(z₃+h(t))+m(t)(x₄+h(t))}/(m₁+m₂+m₃+m(t)) equation (5)

### Wherein,

Z_{g}: gravity point of vehicle body along a vertical direction (variable) [mm]
h: mast lifting height (variable) [mm]
z₁: gravity point of vehicle body along a vertical body (variable) [mm]
z₂: gravity point of inner mast along a vertical direction (constant) [mm]
z₃: gravity point of the both of the fork and the bracket along the vertical direction (constant) [mm]
z₄: gravity point of cargo along the vertical direction (constant) [mm]

### [Calculation of Allowable Acceleration (Deceleration) Velocity αₐ (Step T5)]

In accordance with the gravity point Xg of the vehicle body along a front-rear direction and the gravity point Zg of the vehicle along the vertical direction, the allowable acceleration αₐ is calculated by an equation (6). Wherein, “min” means an operator for selecting a value that is less than another.

αₐ(t)=min(αₘₐₓ,g·X_{g}(t)/Z_{g}(t)) equation (6)

wherein;
αₐ: allowable acceleration (deceleration) velocity [m/s²]
αₘₐₓ: maximum deceleration on non load (constant) [m/s²]
g: gravity acceleration [m/s²]
X_{g}: gravity point of a vehicle body along a front-rear direction (variable) [mm]
Z_{g}: gravity point of a vehicle body along a vertical direction (variable) [mm]

### [Calculation of Allowable Torque T₁ Caused by Allowable Acceleration (Step T6)]

In accordance with the allowable acceleration αₐ, the allowable torque T1 is calculated in an equation (10).

T₁(t)=αₐ·(m₁+m₂+m₃+m(t))·Kᵣ/S_{f} equation (10)

### Wherein,

T₁: allowable torque command caused by allowable acceleration (variable) [N·m]
Kᵣ: driving force→driving torque transfer coefficient (constant) [N·m/N]
S_{f}: safety coefficient (constant) [-]

### [Limit Treatment (Step T7)]

“Limit treatment” is a treatment for controlling the command torque T1(t) calculated by the command torque computer 210 to be less than the allowable torque T1(t) in accordance with acceleration operation amount, a lever signal of the front-rear switch lever and a vehicle velocity.

As described above, in the sixth embodiment, cargo load m(t) and the mast lifting height h(t) are calculated (Steps T1, T2). In the next, in accordance with the cargo load m(t) and the mast lifting height h(t), the gravity point Xg of the vehicle along the front-rear direction and the gravity point Z_{g} of the vehicle along the vertical direction are calculated (Steps T3, T4). Continuously, the allowable acceleration (deceleration) αₐ is calculated based on the gravity point Xg of the vehicle body along the front-rear direction and the gravity point Zg of the vehicle body along the vertical direction (Step T5) and an allowable torque T2 is calculated in accordance with the allowable acceleration (deceleration) αₐ (Step T6). The torque command calculated by the command torque computer 210 controls that the running torque is less than the allowable torque T2 (Step T7) so that the acceleration is controlled not to be over the allowable acceleration (deceleration) αₐ. Therefore, an overturning phenomenon toward the front-rear direction can be prevented when the vehicle is suddenly driven or stopped.

A controller 170 as shown in FIG. 22 may be hardware for operating each steps or software.

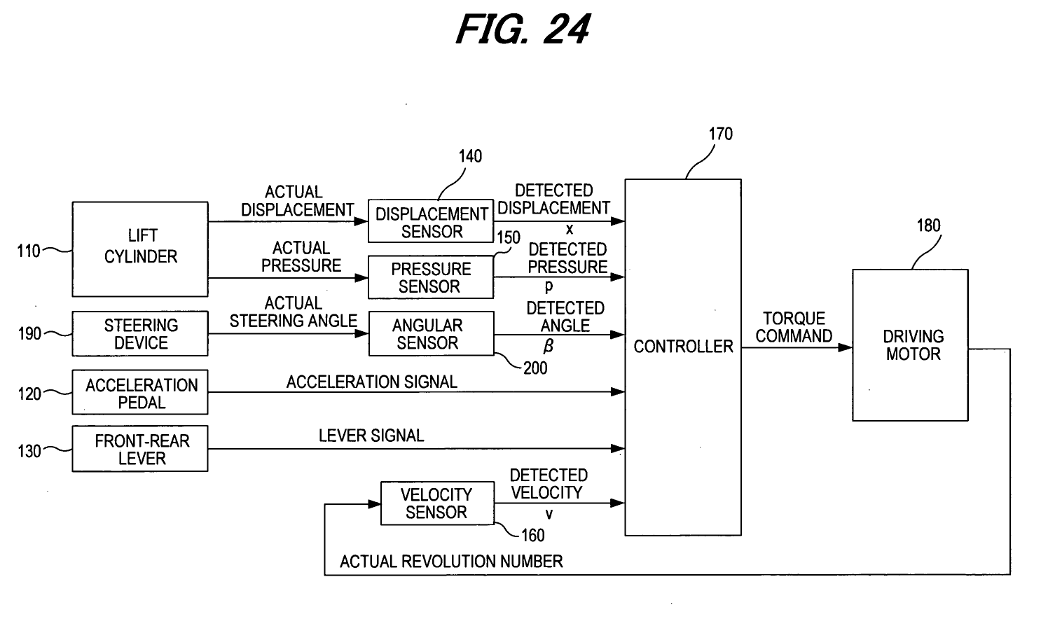

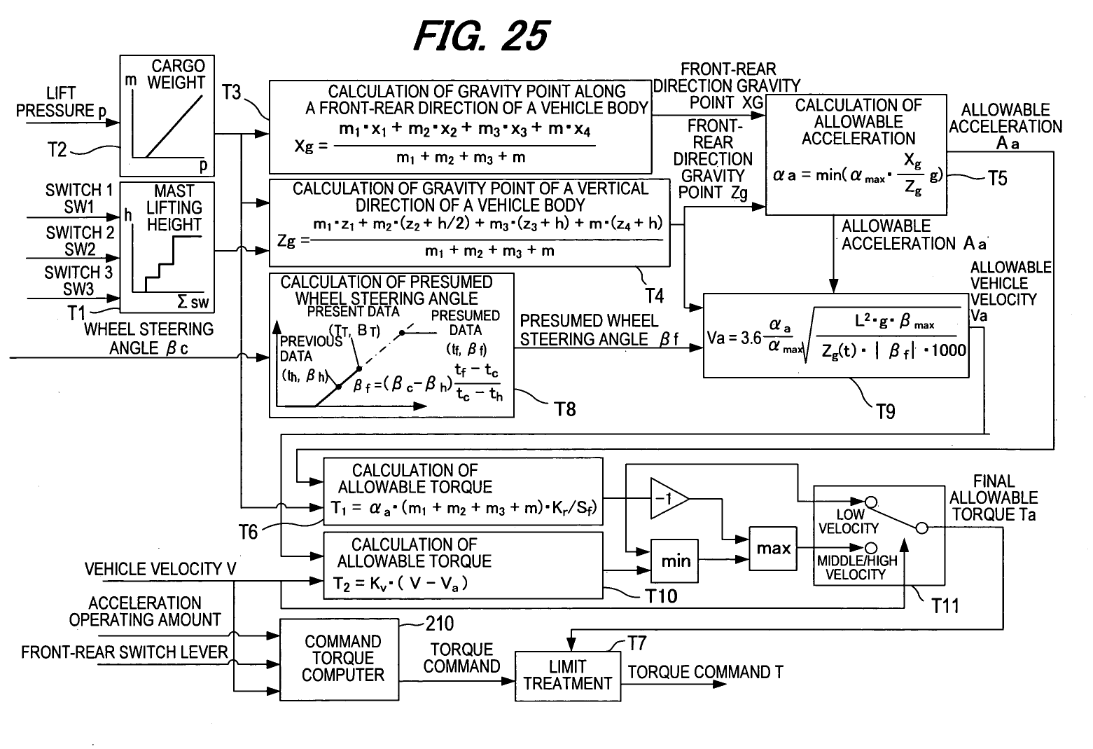

The seventh embodiment will be described with reference to FIG. 24 and FIG. 25. FIG. 24 shows a system structure. FIG. 25 shows a block diagram of an allowable torque treatment.

In the embodiment, in accordance with the mast lifting height, lift load and a wheel steering angle, the allowable acceleration and the allowable vehicle velocity are presumed. The running torque is controlled that the acceleration and the vehicle velocity are not over the allowable range.

As shown in FIG. 23, an actual displacement and an actual pressure of the lift cylinder 110 is detected by the displacement sensor 140 and the pressure sensor 150, respectively. A detected displacement x and a detected pressure p are input to the controller 170. An actual steering angle of the steering device 190 is detected by the angular sensor 200. A detected angle β is input to the controller 170. An actual rotational velocity of the running motor 180 is detected by the velocity sensor 160. A detected velocity v is input to the controller 170.

In accordance with input signals, the controller 170 outputs a torque command to the driving motor 180. In accordance with a block diagram of the allowable torque treatment as shown in FIG. 25, an allowable acceleration and an allowable velocity are presumed. An actual acceleration and an actual velocity is controlled to be less than the allowable value, respectively.

A block diagram of the allowable torque treatment as shown in FIG. 25 includes a calculation of a wheel steering angle presumption (Step T8), a calculation of allowable vehicle velocity (Step T9), a calculation of the allowable torque based on the allowable vehicle velocity (Step T10) and a calculation of the final allowable torque (step T1) in addition to the block diagram of the allowable torque treatment as shown in FIG. 23. Therefore, steps overlapped with the steps of the sixth embodiment are not described.

### [Detection of Wheel Steering Presumed Value β_{f} (Step T8)]

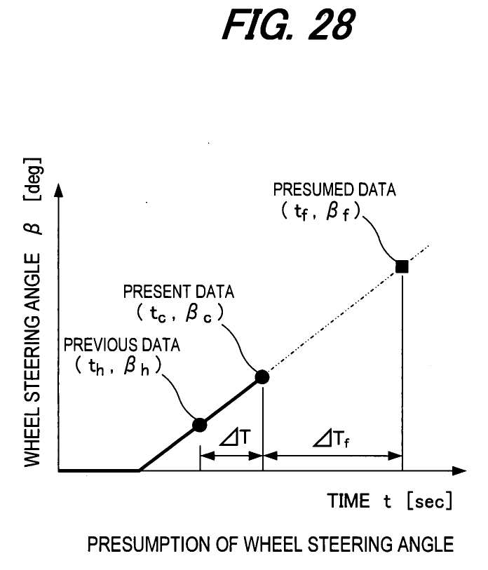

Regarding the wheel steering angle, a relation among previous data (tₕ,βₕ), the present data (t_{c},β_{c}) and the presumption data (t_{f},β_{f}) are indicated in FIG. 28. The presumption value β_{f} of the wheel steering angle is detected in accordance with the equation (3).

$$\begin{matrix}{β}_{f} ( t ) = \{ {β}_{c} ( t ) - {β}_{h} ( t ) \} \times ( Δ {t}_{f} / Δ t ) \\ = \{ {β}_{c} ( t ) - {β}_{c} ( t - Δ t ) \} \times ( Δ {t}_{f} / Δ t )\end{matrix} \qquad equation ( 3 )$$

wherein:
Δt: calculation period (constant) [sec]
β_{c}: present wheel steering angle (variable) [deg]
βₕ=β_{c}(t−Δt): previous wheel steering angle (variable) [deg]
β_{f}: presumption wheel steering angle (variable) [deg]

### [Calculation of Allowable Vehicle Velocity Vₐ (Step T9)]

The allowable vehicle velocity Va is calculated depending on a case whether an absolute value of the presumed wheel steering angle β_{f} is greater than 5.0° or not.

(a) −5.0°□β_{f}(t)□+5.0°

Vₐ(t)=20 km/h

In the case that the presumed wheel steering angle β_{f} is relatively small, the allowable vehicle velocity Vₐ is considered as constant.

(b) |β_{f}(t)|>+5.0°

Vₐ(t)=3.6·(αₙ(t)/αₘₐₓ)·{(L²·g·βₘₐₓ(t))/(Z_{g}(t)·|β_{f}(t)|·1000)}^{0.5} equation (7)

In the case that the presumed wheel steering angle β_{f} is relatively large, the allowable vehicle velocity Va is varied depending on variables such as αₐ (t), aₘₐₓ, L, βₘₐₓ(t) and Z_{g}.

### Wherein:

Va: allowable vehicle velocity (variable) [km/h]
Zg: gravity point of vehicle body along a vertical direction (variable) [mm]
L: a half of front tread (constant) [mm]
βₘₐₓ: maximum wheel steering angle (constant) [deg]
βₘₐₓ₁: maximum wheel steering angle in right turning (constant) [deg]
βₘₐₓ₂: maximum wheel steering angle in left turning (constant) [deg]
β_{f}: presumed wheel steering angle (variable)

### [Calculation of Allowable Torque Command Value T₁ Caused by Allowable Vehicle Velocity (Step T10)]

In accordance with the allowable vehicle velocity Vₐ, the following additional limiter treatment is operated so as to detect the allowable torque command value T2 after operating an existent limiter treatment program.

T₂(t)=Kᵥ·(V(t)−Vₐ(t)) equation (9)

### Wherein:

T₂: depending on allowable vehicle velocity (variable) [N·m]
Kᵥ: torque control gain (constant) [N·m/(km/h)]
V: detected vehicle velocity (variable) [km/h]

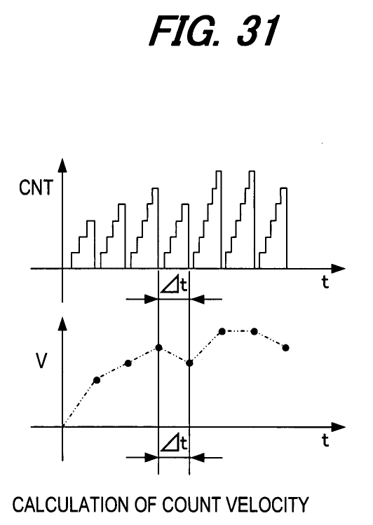

Vehicle velocity V is detected by the velocity sensor 160. Further, as shown in FIG. 31, an encoder count number is reset as zero after every calculation period Δt, so that the vehicle velocity V can be calculated in the following equation (8).

V(t)=CF·CNT(t)/Δt equation (8)

### Wherein:

V(t): vehicle velocity (variable) [km/h]
CNT(t): encoder count number [pulse] (a count is reset as zero after passing every calculation period Δt)
CF: vehicle velocity transfer coefficient (constant) [km/h/(pulse/s)]

[Calculation of the Final Allowable Torque (Step T11)]

The final allowable torque Ta is calculated in accordance with cases (a), (b) and (c) depending on a relation between the allowable torque T₁ calculated based on the allowable acceleration αₐ and the allowable torque command value T₂ calculated based on the allowable vehicle velocity Vₐ.

### (a) |T₂|<T₁

Tₐ(t)=T₂(t)

### (b) |T₂|□T₁ and T₂<0

Tₐ(t)=T₁(t)

### (c) |T₂|□T₁ and T₂<0

Tₐ(t)=−T₁(t) (10)

### [Limit Treatment (Step T7)]

This “limit treatment” is a treatment for controlling the command torque that is calculated by the command torque computer 210 in accordance with the acceleration operation amount, a lever signal of the front-rear switch lever and vehicle velocity not to over the final allowable torque Tₐ.

As described above, in the seventh embodiment, THE cargo weight m(t) and THE mast lifting height h(t) are calculated (Step T1, T2). In the next, a gravity point Xg of vehicle body along the front-rear direction and a gravity point Zg of vehicle body along the vertical direction in accordance with the cargo weight m(t) and the mast lifting height h(t) (Steps T3, T4). Continuously, an allowable acceleration (deceleration) αₐ is calculated based on the gravity point Xg of the vehicle body along the front-rear direction and the gravity point Zg of the vehicle body along the vertical direction (Step T5). An allowable torque T1 is calculated from the allowable acceleration (deceleration) αₐ (Step T6). Further, a presumed wheel steering angle β_{f} is detected (Step T8) and the allowable vehicle velocity Vₐ is calculated in accordance with the gravity point Zg of the vehicle body along the vertical direction and the presumed wheel steering angle β_{f} (Step T9). An allowable torque command value T2 is calculated from the allowable vehicle velocity Va (Step T10). The final allowable torque Ta calculated in accordance with the allowable torque T1 and the calculated torque command value T2 is controlled not to be over the allowable torque T1 calculated by the command torque computer 210 so that an acceleration is not over the allowable acceleration (deceleration) αₐ and a velocity is not over the allowable velocity Vₐ. Therefore, an overturning phenomenon toward a front-rear direction can be prevented when a vehicle rapidly starts or stops and an overturning phenomenon toward a lateral direction can be also prevented when a vehicle is rapidly turned.

A controller 170 as shown in FIG. 24 may be a hardware for operating each steps and a hardware.

### UTILITY IN THE TECHNICAL FIELD

The present invention is also applicable to an electric drive forklift vehicle except forklift vehicle controlled by output of an internal engine.

1. An overturning prevention apparatus for a forklift comprising:
cargo height detection means;
cargo weight detection means;
minimum turning radius memory means;
limit velocity calculation means for calculating a limit velocity at which a forklift is not overturned in accordance with a cargo height, a cargo weight and the minimum turning radius,
actual vehicle velocity detection means;
velocity comparison means for comparing with an actual vehicle velocity and said limit velocity; and
warning device for warming to an operator;
said apparatus characterized in that said warning device is begun to be actuated in the case that actual velocity is reached to said limit velocity.

2. An overturning prevention apparatus for a forklift vehicle in claim 1 characterized in that warming is actuated in multi-steps depending a difference degree between said actual vehicle velocity and said limit velocity in a duration before said actual vehicle velocity reached to said limit velocity.

3. An overturning prevention apparatus for a forklift vehicle in claim 1, said apparatus further comprising:
vehicle velocity presumption means for presuming vehicle velocity at a moment after the predetermined period from the present time in accordance with a present vehicle velocity, said apparatus characterized in that said velocity comparison means compare with a vehicle velocity presumed by said vehicle velocity presumption means and said limit velocity and said warning device is actuated in the case that said presumed vehicle velocity is reached to said limit velocity.

4. An overturning prevention apparatus for a forklift vehicle in claim 1 characterized in that one of decelerating vehicle velocity, lowering said cargo height and prohibiting an incensement of a steering rotational angle is operated after said warning device is actuated.

5. An overturning prevention apparatus for a forklift vehicle comprising:
cargo height detection means;
cargo weight detection means;
minimum turning radius memory means;
limit velocity calculation means for calculating a limit velocity at which said forklift is not overturned in accordance with a cargo height, a cargo weight and the minimum turning radius,
actual vehicle velocity detection means;
velocity comparison means for comparing with an actual vehicle velocity and said limit velocity; and
cargo height lowering device;
said apparatus characterized in that said cargo height lowering device is begun to lower said cargo height in the case that said actual vehicle velocity is over the limit velocity.

6. An overturning prevention apparatus for a forklift vehicle as claimed in claim 5, said apparatus further comprising:
Deceleration means,
Said apparatus characterized in that said deceleration means is begun to be actuated in the case that said actual vehicle velocity is over said limit velocity.

7. An overturning prevention apparatus for a forklift vehicle as claimed in claim 6, said forklift comprising an acceleration pedal,
Said apparatus characterized in that said deceleration means is acceleration shutting means for shutting a connection between an input of pushing said acceleration pedal by an operator and driving means.

8. An overturning prevention apparatus for a forklift vehicle as claimed in claim 6, wherein said forklift is driven by an internal combustion engine, said apparatus characterized of further comprising an output control device for controlling output of said internal combustion engine in order to maintain vehicle velocity less than said limit velocity.

9. An overturning prevention apparatus for a forklift vehicle as claimed in claim 6, said apparatus characterized in that said deceleration means is braking means for braking a vehicle.

10. An overturning prevention apparatus for a forklift vehicle, said apparatus characterized of comprising:
limit rolling moment calculation means; and
actual rolling moment calculation means;
said apparatus characterized in that said braking means decelerate a vehicle velocity in the case that said actual rolling moment is greater than said limit rolling moment.

11. An overturning prevention apparatus for a forklift vehicle as claimed in claim 10, said apparatus characterized in that said braking means decelerate said vehicle velocity and prohibit an incensement of a steering angle in the case that said actual rolling moment is greater than said limit rolling moment.

12. An overturning prevention apparatus for a forklift vehicle as claimed in claim 10, said apparatus further comprising:
cargo height detection means;
cargo weight detection means; and
lateral acceleration detection means for detecting lateral acceleration along a lateral direction of a vehicle,
said apparatus characterized in that said limit rolling moment calculation means calculate limit rolling moment in accordance with a cargo height detected by said cargo height detection means and a cargo weight detected by said cargo weight detection means,
said actual rolling moment calculation means calculate said rolling moment in accordance with said cargo height detected by said cargo height detection means, said cargo weight detected by said cargo weight detection means and lateral acceleration detected by said lateral acceleration detection means.

13. An overturning prevention apparatus for a forklift vehicle as claimed in claim 12, said apparatus characterized in that said lateral acceleration detection means is a lateral acceleration sensor mounted on a vehicle body.

14. An overturning prevention apparatus for a forklift vehicle as claimed in claim 12, said acceleration detection means including wheel steering angle detection means and yaw rate detection means attached to said vehicle body, said apparatus characterized in that said lateral acceleration detection means detect lateral acceleration in accordance with a wheel steering angle detected by said wheel steering angle detection means and a yaw angular velocity detected by said yaw rate detection means.

15. An overturning prevention apparatus for a forklift vehicle as claimed in claim 10, said apparatus comprising rolling moment presumption means for presuming rolling moment at a moment after a predetermined period, said apparatus characterized in that said rolling moment presumed by said rolling moment presumption means is compared to said limit rolling moment.

16. An overturning prevention apparatus for a forklift vehicle comprising:
cargo height detection means;
cargo weight detection means
minimum turning radius memory means;
limit velocity calculation means for calculating a limit velocity at which said forklift is not overturned in accordance with a cargo height, a cargo weight and the minimum turning radius,
actual vehicle velocity detection means;
velocity comparison means for comparing with an actual vehicle velocity and the limit velocity;
a braking device for braking a vehicle; and
a steering resistant device for applying resistant force against a steering device;
said apparatus characterized in that said braking device and said steering resistant device are begun to be actuated in the case that actual vehicle velocity is reached to said limit velocity.

17. An overturning prevention apparatus for a forklift vehicle characterized of comprising:
cargo height detection means;
cargo weight detection means;
front-rear direction gravity point detection means for detecting a gravity point of a vehicle along a front-rear direction of a vehicle in accordance with a cargo height detected by said cargo height detection means and a cargo weight detected by said cargo weight detection means of said vehicle;
vertical direction gravity point detection means for detecting a gravity point of a vehicle along a vertical direction;
allowable acceleration presumption means for presuming allowable acceleration in order to avoid for overturning in accordance with said front-rear direction gravity point detected by said front-rear direction gravity point detection means and said vertical direction gravity point detection means; and
running torque control means for controlling running torque not to over said allowable acceleration presumed by said allowable acceleration presumption means.

18. An overturning prevention apparatus for a forklift vehicle as claimed in claim 17, said apparatus characterized in that said running torque control means compute allowable torque judging from allowable acceleration presumed by said allowable acceleration presumption means and control command torque to a driving motor in accordance with said allowable torque.

19. An overturning prevention apparatus for a forklift vehicle as claimed in claim 17, said apparatus further comprising:
wheel steering angle presumption means for presuming a wheel steering angle; and
allowable velocity presumption means for presuming allowable velocity not to overturn a vehicle along a lateral direction of said vehicle in accordance with said vertical direction gravity point detected by said vertical direction gravity point detection means and said wheel steering angle presumed by said wheel steering angle presumption means;
said apparatus characterized in that said running torque control mean control said running torque not to over said allowable acceleration presumed by said allowable acceleration presumption means and said allowable velocity presumed by said allowable velocity presumption means.

20. An overturning prevention apparatus for a forklift vehicle as claimed in claim 19, said apparatus characterized in that said running torque control means compute allowable torque in accordance with said allowable torque computed by said allowable acceleration presumed by said allowable acceleration presumption means or said allowable velocity presumed by said allowable velocity presumption means and control command torque to a driving motor in accordance with said allowable torque.
